(19) United States
(12) Patent Application Publication
(10) Pub. No.: US 2023/0171072 A1
(43) Pub. Date: Jun. 1, 2023

(54) CROSS-LINK INTERFERENCE ESTIMATION ON SECONDARY CELLS FOR FULL-DUPLEX COMMUNICATIONS

(71) Applicant: QUALCOMM Incorporated, San Diego, CA (US)

(72) Inventors: Abdelrahman Mohamed Ahmed Mohamed Ibrahim, San Diego, CA (US); Muhammad Sayed Khairy Abdelghaffar, San Jose, CA (US); Huilin Xu, Temecula, CA (US); Seyedkianoush Hosseini, San Diego, CA (US); Ahmed Attia Abotabl, San Diego, CA (US)

(21) Appl. No.: 17/540,039

(22) Filed: Dec. 1, 2021

(51) Int. Cl. H04L 5/00; H04B 17/10

(52) U.S. Cl. CPC H04L 5/0073; H04L 5/0048; H04L 5/0064; H04B 17/103; H04L 5/0098

(57) ABSTRACT

Methods, systems, and devices for wireless communications are described for cross-link interference (CLI) measurement and estimation in one or more cells that are inactive or dormant. A user equipment (UE) operating in a first serving cell (e.g., a primary cell (PCell)) may measure one or more reference signals, with the measurements used to estimate one or more CLI measurements of one or more other cells (e.g., one or more secondary cells (SCells)). CLI estimates may be based on scaling factors associated with frequency locations of the PCell and SCell, may be based on a coupling loss estimate associated with different frequency bands, or combinations thereof.

### FIELD OF TECHNOLOGY

The following relates to wireless communications, including cross-link interference estimation on secondary cells for full-duplex communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may communicate with a serving base station, and UEs that are adjacent to one another may communicate with the base station using different carriers or cells. In some examples, a first cell and a second cell may experience different communication directions in a same frequency band, e.g., for a given one or more slots. For instance, the serving base station may communicate with a first UE in uplink in a slot, while communicating with a second UE in downlink in the slot. As the first cell and the second cell use the same time and frequency resources for the communications in different directions, the UEs and base station in the respective cells may suffer increased interference.

### SUMMARY

The described techniques relate to improved methods, systems, devices, and apparatuses that support cross-link interference (CLI) estimation on secondary cells for full-duplex communications. Generally, the described techniques provide for a user equipment (UE), operating in a first serving cell (e.g., a primary cell (PCell)), to measure one or more reference signals, with the measurements used to estimate one or more CLI measurements of one or more other cells (e.g., one or more secondary cells (SCells)). In some cases, the first serving cell and the one or more other cells may operate using a same frequency band (e.g., according to intra-band carrier aggregation (CA)), and a CLI measurement of the first serving cell may be used as the estimated CLI on the one or more other cells. In other cases, the CLI measurement of the first serving cell may be scaled based on a frequency location used by the first serving cell and the one or more other cells, based on a bandwidth difference between communications of the first serving cell and the one or more other cells, based on a coupling loss estimate associated with different frequency bands of the serving cell and the one or more other cells, or any combinations thereof.

In some cases, additionally or alternatively, the UE may perform reference signal measurements in a dormant bandwidth part (BWP) based at least in part on configuration information provided by the base station. In some cases, the configuration information may indicate that the UE is to measure CLI based on periodic or semi-persistent CLI measurement resources (e.g., channel state information (CSI) interference measurement (IM) or zero-power (ZP) sounding reference signal (SRS) resources). In some cases, the CLI measurements may be performed using a set of default spatial receiver parameters (e.g., a default beam) for a measurement resource of a receive beam of the dormant BWP using, or using a set of explicitly defined spatial receiver parameters (e.g., an explicitly defined quasi-co-location type D (QCL-D) for CLI measurement).

A method for wireless communication at a user equipment (UE) is described. The method may include receiving, from a base station, control information that indicates one or more measurement parameters for a first cell, the one or more measurement parameters for identification of cross-link interference of a second cell during concurrent uplink communications and downlink communications of the base station, measuring, based on the control information, one or more reference signals transmitted on the first cell to obtain a cross-link interference measurement for the second cell, and transmitting a measurement report to the base station on the first cell that indicates the cross-link interference measurement.

An apparatus for wireless communication at a UE is described. The apparatus may include a processor, memory coupled with the processor, and instructions stored in the memory. The instructions may be executable by the processor to cause the apparatus to receive, from a base station, control information that indicates one or more measurement parameters for a first cell, the one or more measurement parameters for identification of cross-link interference of a second cell during concurrent uplink communications and downlink communications of the base station, measure, based on the control information, one or more reference signals transmitted on the first cell to obtain a cross-link interference measurement for the second cell, and transmit a measurement report to the base station on the first cell that indicates the cross-link interference measurement.

Another apparatus for wireless communication at a UE is described. The apparatus may include means for receiving, from a base station, control information that indicates one or more measurement parameters for a first cell, the one or more measurement parameters for identification of cross-link interference of a second cell during concurrent uplink communications and downlink communications of the base station, means for measuring, based on the control information, one or more reference signals transmitted on the first cell to obtain a cross-link interference measurement for the second cell, and means for transmitting a measurement report to the base station on the first cell that indicates the cross-link interference measurement.

A non-transitory computer-readable medium storing code for wireless communication at a UE is described. The code may include instructions executable by a processor to receive, from a base station, control information that indicates one or more measurement parameters for a first cell, the one or more measurement parameters for identification of cross-link interference of a second cell during concurrent uplink communications and downlink communications of the base station, measure, based on the control information, one or more reference signals transmitted on the first cell to obtain a cross-link interference measurement for the second cell, and transmit a measurement report to the base station on the first cell that indicates the cross-link interference measurement.

In some examples of the method, apparatuses, and non-transitory computer-readable medium described herein, the first cell and the second cell operate in a same frequency band and the cross-link interference measurement for the second cell is determined as a measurement of the one or more reference signals transmitted on the first cell. In some examples of the method, apparatuses, and non-transitory computer-readable medium described herein, the measurement of the one or more reference signals transmitted on the first cell may be scaled based on a first channel bandwidth of the first cell and a second channel bandwidth of the second cell to determine the cross-link interference measurement.

In some examples of the method, apparatuses, and non-transitory computer-readable medium described herein, the first cell and the second cell operate in a same frequency band and the cross-link interference measurement for the second cell is determined based on a scaling factor that is applied to a measurement of the one or more reference signals transmitted on the first cell. In some examples of the method, apparatuses, and non-transitory computer-readable medium described herein, the scaling factor may be based on a difference between a first center frequency of the first cell and a second center frequency of the second cell.

In some examples of the method, apparatuses, and non-transitory computer-readable medium described herein, the first cell operates in a first frequency band and the second cell operates in a second frequency band that is different than the first frequency band and the cross-link interference measurement for the second cell is determined based on a propagation loss between the UE and a different UE that is based on one or more channel characteristics associated with the second frequency band. In some examples of the method, apparatuses, and non-transitory computer-readable medium described herein, the one or more channel characteristics associated with the second frequency band include estimates of one or more of a path loss, a penetration loss, a foliage loss, a body block loss, an interference margin, a precipitation margin, a fading margin, or any combinations thereof. In some examples of the method, apparatuses, and non-transitory computer-readable medium described herein, the cross-link interference measurement for the second cell may be a frequency range two (FR2) measurement that may be based on a frequency range one (FR1) measurement of the first cell, the propagation loss, and a link-budget associated with the second cell.

In some examples of the method, apparatuses, and non-transitory computer-readable medium described herein, the cross-link interference measurement for the second cell may be a first cross-link interference measurement for a secondary cell (SCell) determined based on a primary cell (PCell) measurement, and a second cross-link interference measurement is determined for a primary SCell (PSCell) of a secondary carrier group (SCG), the second cross-link interference measurement based on the PCell measurement.

Some examples of the method, apparatuses, and non-transitory computer-readable medium described herein may further include operations, features, means, or instructions for receiving, from the base station, an activation indication that communications on the second cell is enabled between the base station and a different UE, measuring, based on the activation indication, the one or more reference signals transmitted on the second cell to obtain a second cross-link interference measurement for the second cell, and discontinuing measuring the one or more reference signals transmitted on the second cell based on the different UE ceasing communications on the second cell. Some examples of the method, apparatuses, and non-transitory computer-readable medium described herein may further include operations, features, means, or instructions for starting a deactivation timer responsive to receiving the activation indication, and where the discontinuing is based on an expiration of the deactivation timer.

Some examples of the method, apparatuses, and non-transitory computer-readable medium described herein may further include operations, features, means, or instructions for determining that a reference signal received power (RSRP) of the one or more reference signals transmitted on the second cell exceeds a threshold value and resetting the deactivation timer to an initial timer value responsive to the determining. Some examples of the method, apparatuses, and non-transitory computer-readable medium described herein may further include operations, features, means, or instructions for receiving, from the base station, a reactivation indication to reactivate measurements of the one or more reference signals transmitted on the second cell and resuming the measuring of the one or more reference signals transmitted on the second cell.

A method for wireless communication at a UE is described. The method may include receiving, from a base station, control information that indicates a first set of parameters for full-duplex communications of first cell and a second cell, and a second set of parameters for one or more measurements associated with the second cell, receiving, from the base station, an indication that the second cell is in a dormant state, measuring, during the dormant state of the second cell, one or more reference signals on the second cell based on the control information, and transmitting a measurement report to the base station that includes the one or more measurements of the one or more reference signals on the second cell.

An apparatus for wireless communication at a UE is described. The apparatus may include a processor, memory coupled with the processor, and instructions stored in the memory. The instructions may be executable by the processor to cause the apparatus to receive, from a base station, control information that indicates a first set of parameters for full-duplex communications of first cell and a second cell, and a second set of parameters for one or more measurements associated with the second cell, receive, from the base station, an indication that the second cell is in a dormant state, measure, during the dormant state of the second cell, one or more reference signals on the second cell based on the control information, and transmit a measurement report to the base station that includes the one or more measurements of the one or more reference signals on the second cell.

Another apparatus for wireless communication at a UE is described. The apparatus may include means for receiving, from a base station, control information that indicates a first set of parameters for full-duplex communications of first cell and a second cell, and a second set of parameters for one or more measurements associated with the second cell, means for receiving, from the base station, an indication that the second cell is in a dormant state, means for measuring, during the dormant state of the second cell, one or more reference signals on the second cell based on the control information, and means for transmitting a measurement report to the base station that includes the one or more measurements of the one or more reference signals on the second cell.

A non-transitory computer-readable medium storing code for wireless communication at a UE is described. The code may include instructions executable by a processor to receive, from a base station, control information that indicates a first set of parameters for full-duplex communications of first cell and a second cell, and a second set of parameters for one or more measurements associated with the second cell, receive, from the base station, an indication that the second cell is in a dormant state, measure, during the dormant state of the second cell, one or more reference signals on the second cell based on the control information, and transmit a measurement report to the base station that includes the one or more measurements of the one or more reference signals on the second cell.

In some examples of the method, apparatuses, and non-transitory computer-readable medium described herein, the second set of parameters provide reference signal resources for measurements of the second cell when the second cell is in the dormant state. In some examples of the method, apparatuses, and non-transitory computer-readable medium described herein, the reference signal resources include periodic or semi-persistent reference signal resources for reference signal transmissions on the second cell.

In some examples of the method, apparatuses, and non-transitory computer-readable medium described herein, the measuring may include operations, features, means, or instructions for receiving configuration for a default receive beam of the second cell for the one or more reference signals and measuring one or more of a reference signal received power (RSRP) or a received signal strength indicator (RSSI) of the one or more reference signals. In some examples of the method, apparatuses, and non-transitory computer-readable medium described herein, the second set of parameters provide spatial receiver parameters for a measurement resource of a receive beam of the second cell, and where the measuring includes, monitoring the receive beam of the second cell for the one or more reference signals based on the spatial receiver parameters, and measuring one or more of a reference signal received power (RSRP) or a received signal strength indicator (RSSI) of the one or more reference signals.

A method for wireless communication at a base station is described. The method may include transmitting, to a UE, control information that indicates one or more measurement parameters of a first cell for identification of cross-link interference at a second cell during concurrent uplink communications and downlink communications of the base station, transmitting a reference signal on the first cell based on the control information, receiving, from the UE, a measurement report that includes one or more measurements of the reference signal on the first cell, determining, based on the measurement report, a cross-link interference measurement for the second cell, and communicating with the UE on the second cell using one or more transmission parameters that are determined based on the cross-link interference measurement.

An apparatus for wireless communication at a base station is described. The apparatus may include a processor, memory coupled with the processor, and instructions stored in the memory. The instructions may be executable by the processor to cause the apparatus to transmit, to a UE, control information that indicates one or more measurement parameters of a first cell for identification of cross-link interference at a second cell during concurrent uplink communications and downlink communications of the base station, transmit a reference signal on the first cell based on the control information, receive, from the UE, a measurement report that includes one or more measurements of the reference signal on the first cell, determine, based on the measurement report, a cross-link interference measurement for the second cell, and communicate with the UE on the second cell using one or more transmission parameters that are determined based on the cross-link interference measurement.

Another apparatus for wireless communication at a base station is described. The apparatus may include means for transmitting, to a UE, control information that indicates one or more measurement parameters of a first cell for identification of cross-link interference at a second cell during concurrent uplink communications and downlink communications of the base station, means for transmitting a reference signal on the first cell based on the control information, means for receiving, from the UE, a measurement report that includes one or more measurements of the reference signal on the first cell, means for determining, based on the measurement report, a cross-link interference measurement for the second cell, and means for communicating with the UE on the second cell using one or more transmission parameters that are determined based on the cross-link interference measurement.

A non-transitory computer-readable medium storing code for wireless communication at a base station is described. The code may include instructions executable by a processor to transmit, to a UE, control information that indicates one or more measurement parameters of a first cell for identification of cross-link interference at a second cell during concurrent uplink communications and downlink communications of the base station, transmit a reference signal on the first cell based on the control information, receive, from the UE, a measurement report that includes one or more measurements of the reference signal on the first cell, determine, based on the measurement report, a cross-link interference measurement for the second cell, and communicate with the UE on the second cell using one or more transmission parameters that are determined based on the cross-link interference measurement.

In some examples of the method, apparatuses, and non-transitory computer-readable medium described herein, the first cell and the second cell operate in a same frequency band and the cross-link interference measurement for the second cell may be determined based on a scaling factor that is applied to the one or more measurements in the measurement report. In some examples of the method, apparatuses, and non-transitory computer-readable medium described herein, the first cell operates in a first frequency band and the second cell operates in a second frequency band that is different than the first frequency band and the cross-link interference measurement for the second cell is determined based on a propagation loss associated with the UE that is based on one or more channel characteristics associated with the second frequency band.

In some examples of the method, apparatuses, and non-transitory computer-readable medium described herein, the one or more channel characteristics associated with the second frequency band include estimates of one or more of a path loss, a penetration loss, a foliage loss, a body block loss, an interference margin, a precipitation margin, a fading margin, or any combinations thereof. In some examples of the method, apparatuses, and non-transitory computer-readable medium described herein, the cross-link interference measurement for the second cell may be a frequency range two (FR2) measurement that is based on a frequency range one (FR1) measurement of the first cell, the propagation loss, and a link-budget associated with the second cell.

In some examples of the method, apparatuses, and non-transitory computer-readable medium described herein, the cross-link interference measurement for the second cell may be a first cross-link interference measurement for a secondary cell (SCell) determined based on a primary cell (PCell) measurement, and a second cross-link interference measurement may be determined for a primary SCell (PSCell) of a secondary carrier group (SCG), the second cross-link interference measurement passed on the PCell measurement.

Some examples of the method, apparatuses, and non-transitory computer-readable medium described herein may further include operations, features, means, or instructions for transmitting, to the UE, an activation indication that communications on the second cell are enabled between the base station and a different UE, the activation indication indicating to the UE to measure cross-link interference on the second cell based on one or more reference signals transmitted on the second cell and receiving, from the UE, one or more second cell cross-link interference measurements responsive to the activation indication. Some examples of the method, apparatuses, and non-transitory computer-readable medium described herein may further include operations, features, means, or instructions for configuring the UE with a deactivation timer that is started responsive to the activation indication, and where the UE discontinues reference signal measurements on the second cell based on an expiration of the deactivation timer.

### BRIEF DESCRIPTION OF THE DRAWINGS

FIGS. 1 and 2 illustrate examples of wireless communications systems that support cross-link interference (CLI) estimation on secondary cells for full-duplex communications in accordance with aspects of the present disclosure.

FIG. 3 illustrates an example of a slot pattern that supports CLI estimation on secondary cells for full-duplex communications in accordance with aspects of the present disclosure.

FIG. 4 illustrates an example of types of full-duplex communications that support CLI estimation on secondary cells for full-duplex communications in accordance with aspects of the present disclosure.

FIG. 5 illustrates an example of measurement techniques that support CLI estimation on secondary cells for full-duplex communications in accordance with aspects of the present disclosure.

FIG. 6 illustrates an example of inter-band measurements that support CLI estimation on secondary cells for full-duplex communications in accordance with aspects of the present disclosure.

FIG. 7 illustrates an example of carrier aggregation and dual connectivity configurations that support CLI estimation on secondary cells for full-duplex communications in accordance with aspects of the present disclosure.

FIG. 8 illustrates an example of a dormant bandwidth part that supports CLI estimation on secondary cells for full-duplex communications in accordance with aspects of the present disclosure.

FIGS. 9 and 10 illustrate examples of process flows that support CLI estimation on secondary cells for full-duplex communications in accordance with aspects of the present disclosure.

FIGS. 11 and 12 show block diagrams of devices that support CLI estimation on secondary cells for full-duplex communications in accordance with aspects of the present disclosure.

FIG. 13 shows a block diagram of a communications manager that supports CLI estimation on secondary cells for full-duplex communications in accordance with aspects of the present disclosure.

FIG. 14 shows a diagram of a system including a device that supports CLI estimation on secondary cells for full-duplex communications in accordance with aspects of the present disclosure.

FIGS. 15 and 16 show block diagrams of devices that support CLI estimation on secondary cells for full-duplex communications in accordance with aspects of the present disclosure.

FIG. 17 shows a block diagram of a communications manager that supports CLI estimation on secondary cells for full-duplex communications in accordance with aspects of the present disclosure.

FIG. 18 shows a diagram of a system including a device that supports CLI estimation on secondary cells for full-duplex communications in accordance with aspects of the present disclosure.

FIGS. 19 through 25 show flowcharts illustrating methods that support CLI estimation on secondary cells for full-duplex communications in accordance with aspects of the present disclosure.

### DETAILED DESCRIPTION

In some wireless communications systems, a UE may communicate with a serving base station in a first cell, while a neighboring UE may communicate with the serving base station in a second cell. The first cell and the second cell may communicate in a same direction in a given time interval. For example, in a slot, the first cell and a second cell may both operate in an uplink direction, where the serving base station may configure the slot for uplink transmission in a same frequency band. However, in some cases, the first cell and the second cell may communicate in different directions in a same slot, which may introduce interference between the two cells, which may be referred to as cross-link interference (CLI).

For example, a serving base station for a first cell (e.g., a primary cell (PCell)) may configure a slot as an uplink for receiving uplink transmissions from a UE, while a second cell may have a downlink transmission to a UE (e.g., a different UE or the same UE). In some cases, full duplex operations may be implemented in which a base station may communicate in both uplink and downlink within a slot. In some cases, dynamic time division duplexing (TDD) may be used for communications, and the serving PCell may switch a slot from downlink to uplink or to full duplex, for example, to reduce latency of an uplink transmission, but doing so may cause interference for itself or one or more SCells. For example, a first cell might be operating in an uplink slot while the second cell is in a downlink or full-duplex slot. In such scenarios, an uplink transmission by a first UE may cause interference to a second UE in the second cell if operating in downlink slot or to the second cell on the uplink. Interference is different in both cases and hence, may benefit from power control or other interference mitigation techniques that may depend on a level of CLI that is present at a first cell from a second cell. Various techniques as described herein may provide measurements for estimation of CLI interference, including in full-duplex operation where a same resource may be configured with two transmission directions.

Existing techniques provide that a UE may measure reference signals of different cells or component carriers and provide measurement reports that can be used by a base station to determine the presence of CLI and adjust scheduling or UL/DL parameters to mitigate CLI. However, there is currently no technique for CLI measurement or estimation in cases where the potentially interfering uplink communications are not being transmitted. For example, if a base station configures a slot for a PCell for a particular transmission direction and would like to switch a SCell or initiate SCell communications in a different direction, a CLI estimate for the corresponding SCell at the PCell may not be available. Such CLI information would be useful at a base station that is scheduling UEs in order to properly account for CLI when the base station seeks to activate the SCell.

In accordance with various techniques as discussed herein, techniques for CLI estimation for an SCell based on measurements made by a UE on a PCell are provided. In some cases, the UE may measure reference signals on the PCell and report measurements to the base station for use in SCell CLI estimation. In some cases where the SCell and PCell operate in adjacent or relatively close frequency locations (e.g., in a same frequency band or intra-band), the PCell measurements may be used directly as SCell CLI measurements. In some cases, when SCell and PCell frequency locations are more offset (e.g., having a relatively large center frequency different in a same frequency band, or in different frequency bands (inter-band)), a scaling factor may be applied to the PCell measurements to determine the SCell CLI. Additionally or alternatively, techniques may be used to estimate CLI for communications in different frequency ranges, such as a frequency range two (FR2) CLI estimate based on a frequency range one (FR1) measurement. In such cases, a coupling loss associated with FR2 communications may be estimated and used to adjust FR1 measurements and estimate the FR2 CLI. Various techniques discussed herein may also be used on dual-connectivity (e.g., NR-DC) deployments where a PCell in a master carrier group (MCG) may be used to estimate CLI of a primary SCell (PSCell) of a secondary carrier group (SCG), or to estimate CLI of a SCell of the SCG.

Additionally or alternatively, techniques as discussed herein may provide for monitoring CLI for dormant SCells, where the SCell remains in an active state but temporarily does not carry shared or control channel communications. In such cases, it may be useful for the base station to have current CLI measurements for the SCell, and periodic or semi-persistent measurement resources may be configured and measured at a UE when the SCell transitions to the dormant state.

Techniques as discussed herein may thus provide for relatively accurate CLI estimates in various different scenarios. Such CLI estimates may be used to set one or more transmission parameters, such as a transmit power, modulation order, coding scheme, number of repetitions, or any combinations thereof, that may account for a presence or magnitude of CLI. Network efficiency and reliability may thus be enhanced through higher likelihood of successful communications, through more accurately tuned transmission parameters (e.g., transmit power, MCS, number of repetitions, etc.), or any combinations thereof.

Aspects of the disclosure are initially described in the context of wireless communications systems. Various examples of CLI and estimations thereof are then discussed. Aspects of the disclosure are further illustrated by and described with reference to process flows, apparatus diagrams, system diagrams, and flowcharts that relate to CLI estimation on secondary cells for full-duplex communications.

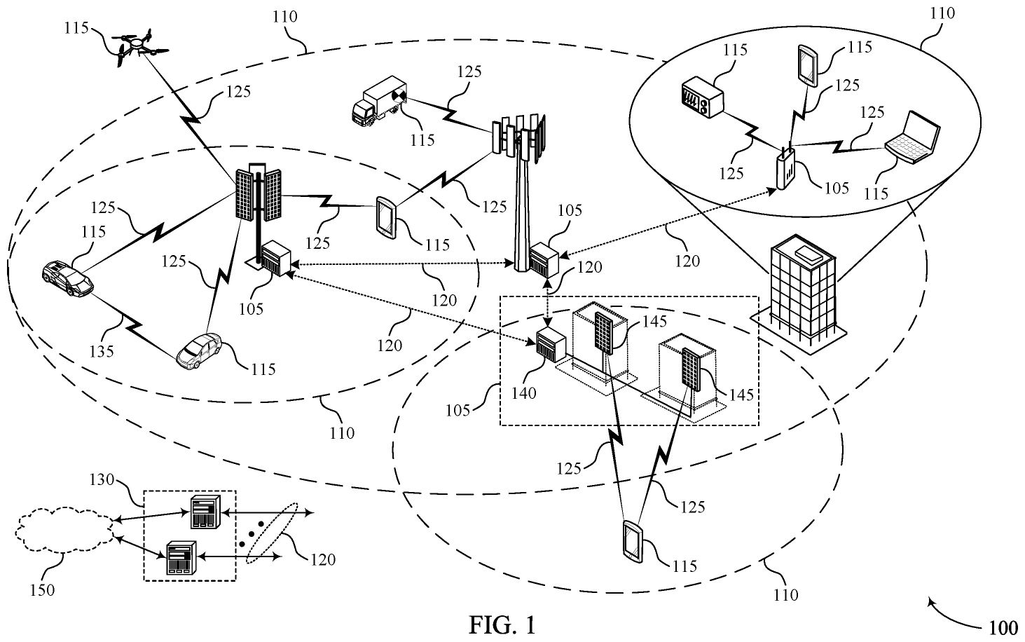

FIG. 1 illustrates an example of a wireless communications system 100 that supports CLI estimation on secondary cells for full-duplex communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105 (e.g., in FR2 or higher frequency bands), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, a UE 115 operating in a first serving cell (e.g., a PCell) may measure one or more reference signals, with the measurements used to estimate one or more CLI measurements of one or more other cells (e.g., one or more SCells). In some cases, the first serving cell and the one or more other cells may operate using a same frequency band (e.g., according to intra-band carrier aggregation (CA)), and a CLI measurement of the first serving cell may be used as the estimated CLI on the one or more other cells. In other cases, the CLI measurement of the first serving cell may be scaled based on a frequency location used by the first serving cell and the one or more other cells, based on a bandwidth difference between communications of the first serving cell and the one or more other cells, based on a coupling loss estimate associated with different frequency bands of the serving cell and the one or more other cells, or any combinations thereof.

Additionally or alternatively, the UE 115 may perform reference signal measurements in a dormant bandwidth part (BWP) based at least in part on configuration information provided by a base station 105. In some cases, the configuration information may indicate that the UE 115 is to measure CLI based on periodic or semi-persistent CLI measurement resources (e.g., channel state information (CSI) interference measurement (IM) or zero-power (ZP) sounding reference signal (SRS) resources). In some cases, the CLI measurements may be performed using a set of default spatial receiver parameters (e.g., a default beam) for a measurement resource of a receive beam of the dormant BWP using, or using a set of explicitly defined spatial receiver parameters (e.g., an explicitly defined quasi-co-location type D (QCL-D) for CLI measurement).

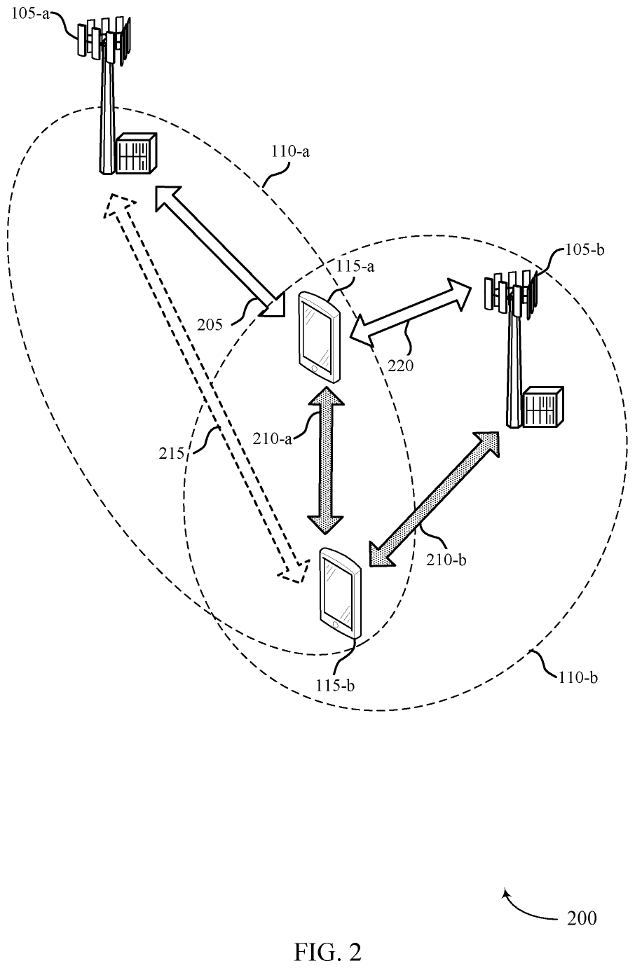

FIG. 2 illustrates an example of a wireless communications system 200 that supports CLI estimation on secondary cells for full-duplex communications in accordance with aspects of the present disclosure. The wireless communications system 200 may include a first base station 105-a, a second base station 105-b, a first UE 115-a, and a second UE 115-a, which may be examples of base stations 105 and UEs 115 as described with reference to FIG. 1. Each base station 105 may serve a UE 115 in one or multiple cells in a coverage areal 10 (e.g., first base station 105-a may have first coverage area 110-a and second base station 105-b may have second coverage area 110-b) and may communicate with the respective UE 115 over a communication link 205.

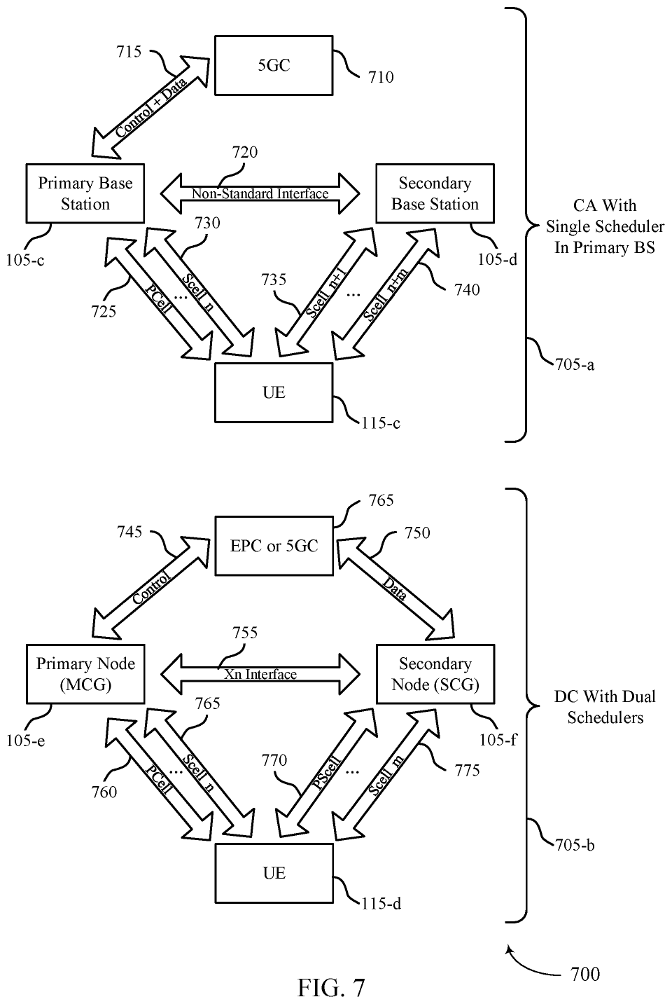

In the example of FIG. 2, each base station 105 may serve multiple cells (e.g., a PCell and SCell). Further, in some cases a UE 115 may operate in a dual connectivity configuration (e.g., as discussed in more detail with reference to FIG. 7), in which a UE 115 communicates via multiple base stations 105. In this example, the first base station 105-a may communicate with the first UE 115-a via a communication link 205, while the second base station 105-b may communicate with one or more UEs via associated communication links (e.g., first UE 115-a via communication link 220).

In some cases, different cells of first base station 105-a (or second base station 105-b) may operate in a same direction in a given time period. For example, the first base station 105-a and the second base station 105-b may configure a same slot for uplink transmission in a same or similar frequency band. The slot may be associated with or may have a format (e.g., a TTI format) based on the configured direction of communications.

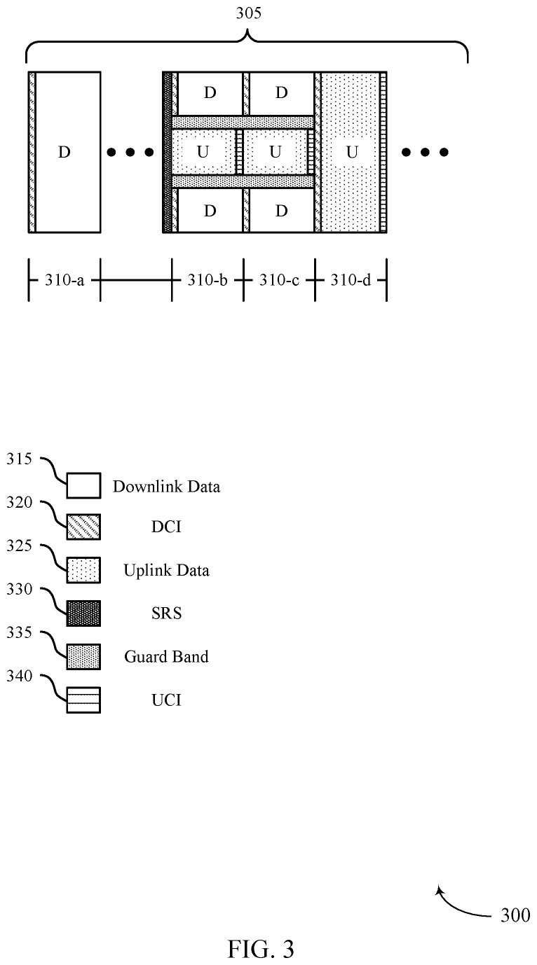

In some scenarios, however, one or more cells may operate in at least partially different communication directions in a same slot. For example, as described with reference to FIG. 3, the first base station 105-a may configure a full duplex slot. In such examples, the first base station 105-a and the first UE 115-a may be communicating in downlink in the slot via communication link 205, while the first base station 105-a and the second UE 115-b may be communicating in uplink in the slot via communication link 215. As the same time resources are being used by both UEs 115, the conflicting communications directions may introduce or increase interference, e.g., interference 210-a for the first UE 115-a, and interference 210-b for the second base station 105-b, or both.

As an example, the first UE 115-a may receive a downlink message (e.g., a physical downlink shared channel (PDSCH) transmission via communication link 205) from the first base station 105-a in the slot, and the second UE 115-a may transmit an uplink message (e.g., a physical uplink control channel (PUCCH) transmission via communication link 215) in the slot. The uplink transmission may cause interference 210-a at the first UE 115-a as the first UE 115-a attempts to receive the downlink transmission in the slot. In some cases, the uplink transmission may introduce interference 210-b as well (e.g., at the second base station 105-b). The interference 210-a and the interference 210-b may be further increased as the distance between the second UE 115-b and first UE 115-a and the second base station 105-b decreases.

Further, in some cases, one or multiple UEs 115 may operate in a full duplex mode. For example, the first UE 115-a may operate in full duplex mode to concurrently transmit (e.g., on a PCell served by the first base station 105-a) and receive (e.g., on a SCell, where both the PCell and the SCell are served by first base station 105-a) communications. In such cases, the first UE 115-a may generate self-interference, where the uplink transmission of the first UE 115-a may cause interference with the concurrent downlink transmission. Other types of full duplex operations may include UE-only full duplex with multi-TRP, such as first UE 115-a transmitting an uplink communication via communication link 205 to the first base station 105-a and receiving a downlink communication via communication link 220 from the second base station 105-b. In such cases, the first UE 115-a again may generate self-interference, where the uplink transmission of the first UE 115-a may cause interference with the concurrent downlink transmission.

Thus, the first UE 115-a may have a number of possible different sources of interference, including inter-cell interference from other base stations 105, intra-cell CLI from UEs in the same cell, inter-cell CLI from UEs in adjacent cells, self-interference for full-duplex UEs. Various aspects of the present disclosure provide techniques for estimating various types of interference, which may allow for adjustment of transmission parameters based on the estimated interference. For example, if estimated interference is high, a higher transmit power, lower modulation order, lower coding rate, additional repetitions, or any combinations thereof, may be used for associated communications. Likewise, if estimated interference is low, a lower transmit power, higher modulation order, higher coding rate, fewer repetitions, or any combinations thereof, may be used for associated communications. Thus, efficiency and reliability of communications may be enhanced.

FIG. 3 illustrates an example of a slot pattern 300 that supports CLI estimation on secondary cells for full-duplex communications in accordance with aspects of the present disclosure. In some examples, the slot pattern 300 may implement aspects of or be implemented by the wireless communications systems 100 or 200. For example, the slot pattern 300 may include slots 310 used for communications between a base station and a UE, where each slot 310 may be configured for uplink, downlink, or full duplex communications.

The slot pattern 300 may include a slot format pattern 305 for the slots 310. The slot format pattern 305 may be used by a serving cell for communications with a UE, where the serving cell may configure each slot 310 for communications in a respective uplink or downlink direction, or for both uplink and downlink. For example, slot 310-a may be configured by the serving cell for downlink communications, while slot 310-d may be configured for uplink communications. In this example, slot 310-b and slot 310-c may be configured for full duplex communications, such that each slot 310-b and 310-c may include both downlink and uplink communications. Each slot 310 may include data and control information for the corresponding communication direction; for instance, a downlink slot (such as slot 310-a) may include downlink data 315 and downlink control information 320 (DCI), while an uplink slot (such as slot 310-d) may include uplink data 325 and uplink control information 340 (UCI). A full duplex slot, such as slot 310-b and 310-c, may include downlink data 315 and DCI 320 and uplink data 325 and UCI 340, as well as a guard band 335 between the uplink data 325 and the downlink data 315 (e.g., to reduce interference between the opposing directions of communication). In this example, sounding reference signal 330 (SRS) resource may be configured prior to the full duplex slot 310-b, which may be used by the serving cell to measure an uplink channel.

In some cases, the full duplex slots 310-b and 310-c may include frequency resources in overlapping bands (e.g., in-band full-duplex (IBFD)) or in adjacent bands (e.g., sub-band full-duplex (SBFD)). In a given full duplex slot 310-b and 310-c, a half-duplex UE may either transmit in the uplink band or receive in the downlink band. Further, in a given full duplex slot 310-b and 310-c, a full duplex UE can transmit in the uplink band and/or receive in the downlink band in the same slot. In some cases, full duplex slots 310-b and 310-c may contain downlink-only symbols, uplink-only symbols, or full-duplex symbols.

In SBFD, the serving base station may configure the downlink transmission to a UE in frequency domain resources adjacent to the frequency domain resources configured for uplink transmission of another UE. For example, a first UE may transmit uplink in middle of the band and a second UE may receive downlink transmissions in the adjacent frequency resources. In such cases, the uplink transmissions of the first UE may cause CLI to the downlink reception at the second UE. For example, CLI may be due to energy leakage caused by timing and frequency unalignment between the two UEs, due to automatic gain control (AGC) mismatch if the second UE AGC is driven by the downlink serving cell signal of the second UE but the CLI is strong enough to saturate the AGC. In some cases, intra-cell CLI may limit the performance of some UEs, such as if CLI from uplink transmissions of nearby users in IBFD or CLI leakage to DL in SBFD mode.

The slot format pattern 305 may be configured by a serving base station for communications with one or multiple UEs. In some cases, the serving base station may utilize opportunistic sub-band full duplex operations and may convert a slot 310 to a full duplex slot. For example, the slot 310-b and the slot 310-c initially may be configured by the serving base station for downlink communications, and may be converted by the serving base station into full duplex slots. Although converting a downlink slot to an uplink slot or a full duplex slot may reduce latency in uplink communications in the slot 310, the difference in communication directions of the slot may introduce or increase interference. Further, because the uplink transmissions in the converted slots may not have been measured, the serving base station may not have a CLI measurement associated with the changed configuration. As described herein, a measurement report provided by a UE for one or more carriers (e.g., a PCell measurement corresponding to the downlink resources) may be used to estimate CLI on a same or different carrier.

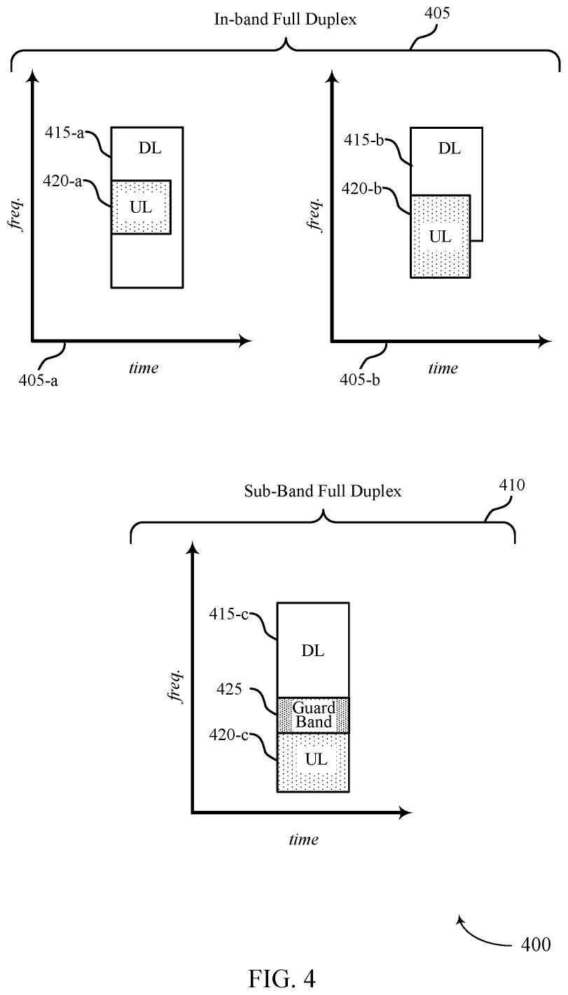

FIG. 4 illustrates an example of a types of full-duplex communications 400 that supports CLI estimation on secondary cells for full-duplex communications in accordance with aspects of the present disclosure. In some examples, the types of full-duplex communications 400 may implement aspects of or be implemented by the wireless communications systems 100 or 200. For example, the full-duplex communications 400 may in-band full duplex communications 405 and sub-band full duplex communications 410.

In the example of FIG. 4, the in-band full duplex communications 405 may include fully overlapping in-band full duplex communications 405-a in which downlink resources 415-a and uplink resources 420-a may use the same time and frequency resources that are fully overlapping. The in-band full duplex communications 405 may also include partially overlapping in-band full duplex communications 405-b in which downlink resources 415-b and uplink resources 420-b may use partially overlapping time resources, frequency resources, or both. The sub-band full duplex communications 410 may include downlink resources 415-c and uplink resources 420-c that are in the same time domain resources, but use different frequency resources that may be separated by a guard band 425. In some cases, downlink resources 415 may be associated with a first carrier (e.g., a first cell or a PCell), and uplink resources 420 may be associated with a second carrier (e.g., a second cell or SCell), and one or more measurements associated with the first carrier may be used to estimate CLI on the second carrier. In some cases, each carrier may have a full duplex slot, so both can have SBFD or IBFD slots.

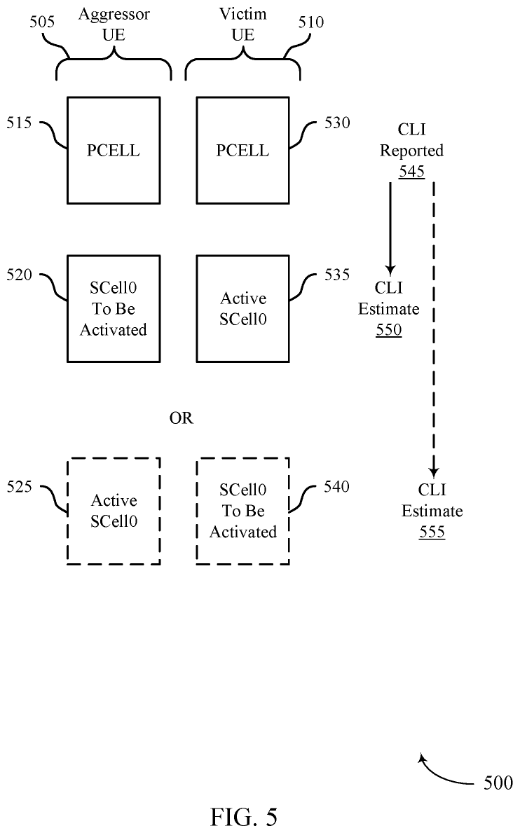

FIG. 5 illustrates an example of measurement techniques 500 that support CLI estimation on secondary cells for full-duplex communications in accordance with aspects of the present disclosure. In some examples, the measurement techniques 500 may be implemented by the wireless communications systems 100 or 200. In this example, an aggressor UE 505 and a victim UE 510 may be operating in proximity to each other and be served by a serving base station. The victim UE 510 may be susceptible to CLI from the aggressor UE 505 when receiving downlink communications.

In the example of FIG. 5, the aggressor UE 505 may have an active PCell 515 connection, and the victim UE 510 may have an active PCell 530 connection and an active SCell 535 connection. The serving base station may determine that a SCell 520 connection for the aggressor UE 505 is to be activated. In some cases, the SCell 520 may be activated by the serving base station using full duplex communications at the base station. In other cases, the aggressor UE 505 may have an active SCell 525 connection and the victim UE 510 may have an inactive SCell 540 that is to be activated. In either case, the serving base station may not have a current measurement of CLI for the victim UE 510 associated with the cell that is to be activated.

In accordance with various aspects discussed herein, a reported CLI 545 associated with the PCell 530 for the victim UE 510 may be used to determine a CLI estimate 550 for SCell 520 (or may be used to determine CLI estimate 555 for SCell 540). In some cases, the reported CLI 545 may be used by the serving base station as the CLI estimate 550 (or CLI estimate 555) directly (e.g., without adjustment). In some cases such a direct estimate may be used when the PCell 530 and Scell 535 are in the same band (e.g., for intra-band carrier aggregation). In some cases, the reported CLI 545 may include one or multiple measurements, such as received signal strength indicator (RSSI) measurements, and the one or multiple measurements may be adjusted to account for different bandwidths of the PCell 530 and SCell 535 (e.g., if the SCell 535 bandwidth is less than PCell 530 bandwidth, the RSSI in the reported CLI 545 may be adjusted based on a ratio of the PCell 530 bandwidth and SCell 535 bandwidth). In some cases, a scaling factor may be applied to measurements of the reported CLI 545 to determine the CLI estimate 550. For example, the scaling factor may be based on a frequency location of the PCell 530 and SCell 535 (e.g., measurements are scaled according to a frequency difference based on different signal fading of different relative frequencies).

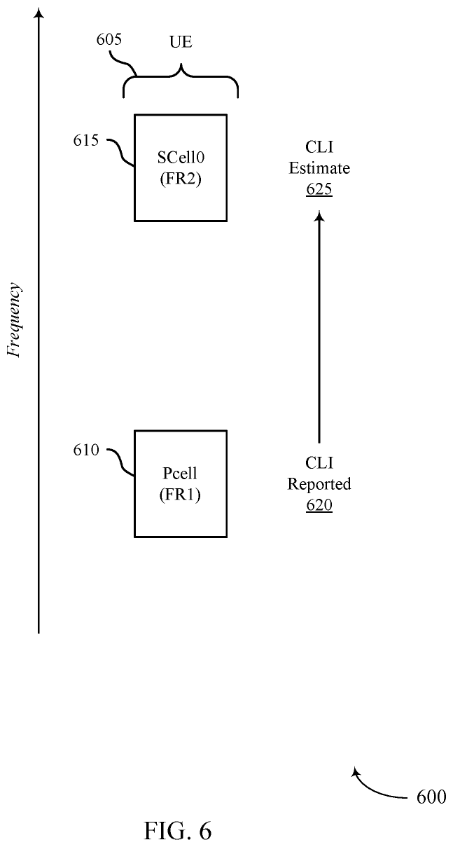

In some cases, such as in inter-band carrier aggregation, different coupling losses between the victim UE 510 and aggressor UE 505 may be present and may depend on frequency. For example, CLI measurements on FR1 may be lower than CLI measurements on FR2 because of the higher propagation loss and beam directivity in FR2. In some cases, CLI measurements on FR1 may be extrapolated for FR2 based on coupling loss estimates, as is discussed in more detail with reference to FIG. 6.

Once the SCell 520 is activated (or the SCell 540 is activated), the serving base station may configure the aggressor UE 505 to transmit a reference signal (e.g., a CLI-SRS) on the SCell 520 (or SCell 525), and may configure the victim UE 510 to measure CLI on the SCell 535 (or SCell 540). In some cases, the activated SCell 520 (or SCell 540) may only be activated for a limited time, and associated CLI measurement procedures may be discontinued. Thus, the aggressor UE 505 may stop the transmission of CLI-SRS on the SCell 520 due to deactivation (e.g., based on reception of a deactivation MAC control element (MAC-CE) or expiration of a deactivation timer such as a configured sCellDeactivationTimer). In some cases, the serving base station may transmit a MAC-CE to deactivate a CLI measurement resource at victim UE 510, where the CLI measurement resource corresponds to the deactivated aggressor UE 505 CLI-SRS. In other cases, for CLI measurement on SCell 535 (or on SCell 540), if the serving base station configures the aggressor UE 505 with a deactivation timer (e.g., sCellDeactivationTimer), then the serving base station may also configure victim UE 510 with a CLI-measurement expiration timer to deactivate the associated CLI measurement resource. In some cases where the victim UE 510 is configured with the expiration timer, the timer may be reset or restarted if a CLI measurement on the CLI measurement resource exceeds a threshold value (e.g., if RSRP>RSRP_threshold). Such a measurement may indicate that the aggressor UE 505 SCell 520 remains active. Additionally or alternatively, the serving base station may transmit a MAC-CE to the victim UE 510 to reactivate the CLI measurement resource upon the expiration of the timer.

FIG. 6 illustrates an example of inter-band measurements 600 that support CLI estimation on secondary cells for full-duplex communications in accordance with aspects of the present disclosure. In some examples, the inter-band measurements 600 may be implemented by the wireless communications systems 100 or 200. In this example, a PCell 610 may be active in a first frequency band (e.g., FR1) for a UE 605, and reported CLI measurements 620 may be used to determine an estimated CLI 625 of a SCell 615 in a second frequency band (e.g., FR2).

As discussed with reference to FIG. 5, CLI measurements on FR1 may be lower than CLI measurements on FR2 because of the higher coupling loss and beam directivity in FR2. In some cases, the reported CLI measurements 620 in FR1 may be extrapolated based on estimated coupling loss. For example, coupling loss may be estimated according to:

Total Losses (dB)=Path loss (dB)+penetration loss (dB)+foliage loss (dB)+body block loss (dB)+interference margin (dB)+rain/ice margin (dB)+slow fading margin (dB)

where the loss terms are frequency dependent. In this example, the coupling loss may be estimated for FR1 based on the reported CLI measurements 620 in FR1. The coupling loss for FR2 may then be estimated based on the estimated FR1 coupling loss, by adjusting the terms in link-budget equation based on modeled or expected loss differences based on the frequencies of the PCell 610 and SCell 615. Based on the estimated FR2 coupling loss, the CLI estimate 625 for FR2 may be determined based on the reported CLI measurements 620 in FR1 and the differences in coupling loss between FR1 and FR2. The serving base station may use the CLI estimate 625 to adjust one or more transmission parameters for the SCell 615, in order to mitigate for CLI.

FIG. 7 illustrates an example of a carrier aggregation and dual connectivity configurations 700 that supports CLI estimation on secondary cells for full-duplex communications in accordance with aspects of the present disclosure. In some examples, CLI may be estimated in carrier aggregation and dual connectivity configurations 700, and may be implemented by the wireless communications systems 100 or 200. In the examples of FIG. 7, multiple TRPs or base stations 105 may provide different carriers or cells to a UE 115.

In a first example 705-a, UE 115-c may be configured for carrier aggregation with cells served by a primary base station 105-c and a secondary base station 105-d, with a single scheduler in the primary base station 105-c. Control and data 715 may be exchanged between the primary base station 105-c and a core network 710 (e.g., a 5G core (5GC)). The primary base station 105-c and secondary base station 105-d have, for example, a non-standard interface 720 (e.g., communication may be according to a proprietary or otherwise non-standardized interface). In this first example 705-a, the primary base station 105-c may serve PCell 725 and one or more SCells 730, and the secondary base station 105-d may serve one or more SCells 735 through 740. In such cases, one or more of the different SCells 730 or 735 through 740 may be activated at different times, and associated CLI may be estimated based on a CLI report of the PCell 725. The CLI estimates may be determined in accordance with techniques discussed herein, such as discussed with reference to FIGS. 5 and 6.

In a second example 705-b, UE 115-d may be configured for dual connectivity (DC) with cells served by a primary node 105-e of a master carrier group (MCG) and a secondary node 105-f of a secondary carrier group (SCG), where dual schedulers may be present at the primary node 105-e and secondary node 105-f In this example, control information 745 may be exchanged between the primary node 105-e and a core network 765 (e.g., an evolved packet core (EPC) of 5GC) and data 750 may be exchanged between the secondary node 105-f and the core network 765. The primary node 105-e and secondary node 105-f may have, for example, a standardized interface 755 (e.g., an Xn interface). In this second example 705-b, the primary node 105-e may serve PCell 760 and one or more SCells 775, and the secondary node 105-f may serve a primary SCell 770 (PSCell) and one or more SCells 775. In such cases, one or more of the different SCells 770 or 775, or PSCell 770, may be activated at different times, and associated CLI may be estimated based on a CLI report of the PCell 760. The CLI estimates may be determined in accordance with techniques discussed herein, such as discussed with reference to FIGS. 5 and 6. In some cases, the carrier aggregation or DC of the examples 705 may provide carriers in different frequency bands (e.g., MCG with FR1 carrier aggregation and SCG with FR2 aggregation; MCG with FR1 aggregation and SCG with FR1+FR2 aggregation, etc.). In some cases, base stations 105 or serving nodes may determine estimates for CLI_SPcell and CLI_SCell in SCG from CLI PCell in MCG, and schedulers in the MCG and SCG may coordinate to provide suitable transmission parameters. Further, CLI_Spcell and CLI_Scell may be in FR1 or FR2 depending on the scenario.

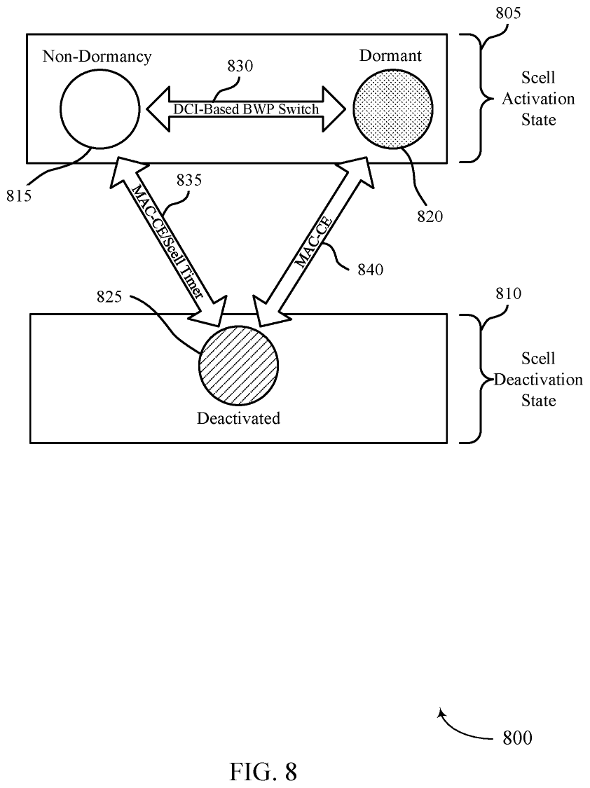

FIG. 8 illustrates an example of a dormant bandwidth part 800 that supports CLI estimation on secondary cells for full-duplex communications in accordance with aspects of the present disclosure. In some examples, the dormant bandwidth part 800 may be implemented by wireless communications systems as discussed herein, such as the wireless communications systems 100 or 200. In this example, a SCell may be configured and have different states, including an SCell activation state 805 and a SCell deactivation state 810.

In some cases, the SCell activation state 805 may have two associated states, including a non-dormancy state 815 (e.g., supporting active communications) and a dormant state 820. The dormant state 820 may be a subset of SCell activation state 805, and when the SCell is in the dormant state 820 the UE may not perform control channel (e.g., physical downlink control channel (PDCCH)) monitoring, and can perform CSI-RS measurements. Further, in the dormant state 820, uplink or downlink grants are not provided. Such a dormant state 820 may support fast SCell activation, which may be beneficial in cases where SCell communications may be expected and low latency for such communications is desired. In some cases, during a period of little or no traffic activity, the SCell may move from non-dormancy state 815 to the dormant state 820, and the UE may continue monitoring for control channel information on the PCell, but not on the SCell in the dormant state 820. In cases where it is determined that the SCell is unlikely to be needed for longer periods, the SCell may be moved to deactivated state 825. The deactivated state 825 may be entered from the non-dormancy state 815 based on a MAC-CE or SCell timer expiration 835, for example. The deactivated state 825 may also be entered from the dormant state 820 based on a MAC-CE 840, for example. In some cases, the UE may transition the SCell activation state 805 between the non-dormancy state 815 and the dormant state 820 based on a DCI-based bandwidth part (BWP) switch 830.

In cases where the dormant state 820 is implemented, it may be beneficial to provide CLI measurements that may be used to set transmission parameters to provide mitigation of CLI if needed. In some cases, the UE may perform periodic or semi-persistent reference signal measurements in the dormant BWP (e.g., channel state information reference signal (CSI-RS) measurement). In some cases, the serving base station may also configure the UE to measure CLI based on periodic or semi-persistent CLI measurement resources (e.g., CSI interference management (CSI-IM) or zero power SRS (ZP-SRS) resources). The CLI measurements may then be used by the serving base station for scheduling of communications on the SCell when transitioned back to the non-dormancy state 815. In some cases, CLI measurements may be based on a configured receive beam (e.g., a physical downlink shared channel (PDSCH) receive beam). However, in the dormant state 820 there are not ongoing PSDCH receptions, and thus no associated receive beam for CLI measurements. In some cases, the serving base station may configure the UE to measure CLI in the dormant BWP using a default receive beam (e.g., a beam for PDCCH detection), or to measure CLI in a CLI measurement resource that is explicitly defined with receive beam parameters (e.g., quasi-co-location (QCL) type D (QCL-D) parameters) for CLI measurements (e.g., RRC signaling may provide explicit receive beam parameters for CLI measurements in dormant state 820).

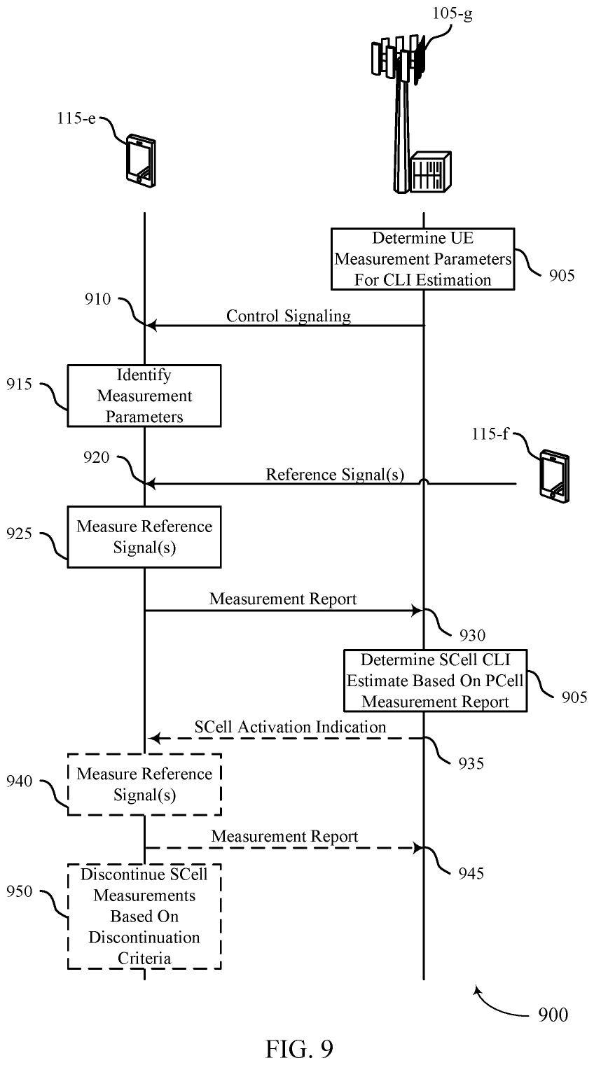

FIG. 9 illustrates an example of a process flow 900 that supports CLI estimation on secondary cells for full-duplex communications in accordance with aspects of the present disclosure. In some examples, the process flow 900 may implement aspects of wireless communication systems 100 or 200. For example, the process flow 900 may include a base station 105-g and a UE 115-e, which may be examples of corresponding wireless devices as described herein. In the following description of the process flow 900, the operations between the base station 105-g and the UE 115-e may be transmitted in a different order than the order shown, or the operations performed by the base station 105-g and the UE 115-e may be performed in different orders or at different times. Certain operations may also be left out of the process flow 900, or other operations may be added to the process flow 900. While the base station 105-g and the UE 115-e are shown performing operations of process flow 900, any wireless device may perform the operations shown. Further, while FIG. 9 illustrates an example of communications between the base station 105-g and the UE 115-e, the techniques described herein may be applied to communications between any number of wireless devices. In the example of FIG. 9, the UE 115-e may be served by the base station 105-g, which may be an example of a serving base station and may be associated with a serving cell.

At 905, the base station 105-e may determine UE measurement parameters for CLI estimation. For example, the base station 105-g may determine CLI measurement resources for a PCell that are to be measured by the UE 115-e. Further, in some cases, the base station 105-f may determine one or more timing parameters that may be used for SCell CLI measurements, such as an expiration timer value for use in determining when SCell CLI measurements are to be discontinued. Additionally or alternatively, the measurement parameters may include one or more threshold values for determining to reset an expiration timer or determining to continue SCell CLI measurements based on measured signal levels relative to the threshold values. At 910, the base station 105-g may transmit, to the UE 115-e, control signaling (e.g., RRC signaling, a MAC-CE, DCI) indicating the measurement parameters.

At 915, the UE 115-e may identify the measurement parameters. In some cases, the measurement parameters may be PCell measurement parameters that are to be used for CLI estimation of an SCell. The measurement parameters may include, for example, a CLI measurement resource (e.g., corresponding to SRS resources on the PCell), a measurement report format for providing CLI measurements, a timing for transmitting measurement reports, or any combinations thereof.

At 920, an aggressor UE 115-f may transmit one or more reference signals, which may be received at the UE 115-e. The reference signals may include, for example, a SRS that is transmitted on the PCell. At 925, the UE 115-e may measure the reference signals. In some cases, the UE 115-e may measure RSRP, RSSI, or similar parameters, using CLI measurement resources that are configured by the measurement parameters.

At 930, the UE 115-e may transmit a measurement report to the base station 105-g. At 935, the base station 105-g may determine a SCell CLI estimate based on the measurement report of PCell CLI measurements. In some cases, the PCell CLI may be used directly, or may be scaled based on one or more scaling factors, such as discussed with reference to FIGS. 5 and 6.

Optionally, at 940, the base station 105-g may transmit a SCell activation indication. At 940, the UE 115-e, based on the SCell activation indication, may measure one or more reference signals on the SCell for CLI measurements. The CLI measurements may be transmitted, at 945, to the base station 105-g in one or more measurement reports that indicate SCell CLI measurements. At 950, the UE 115-e may discontinue SCell measurements based on one or more discontinuation criteria that may be provided with the measurement parameters (e.g., based on a deactivation timer, measurement thresholds, etc., as discussed with reference to FIG. 5).

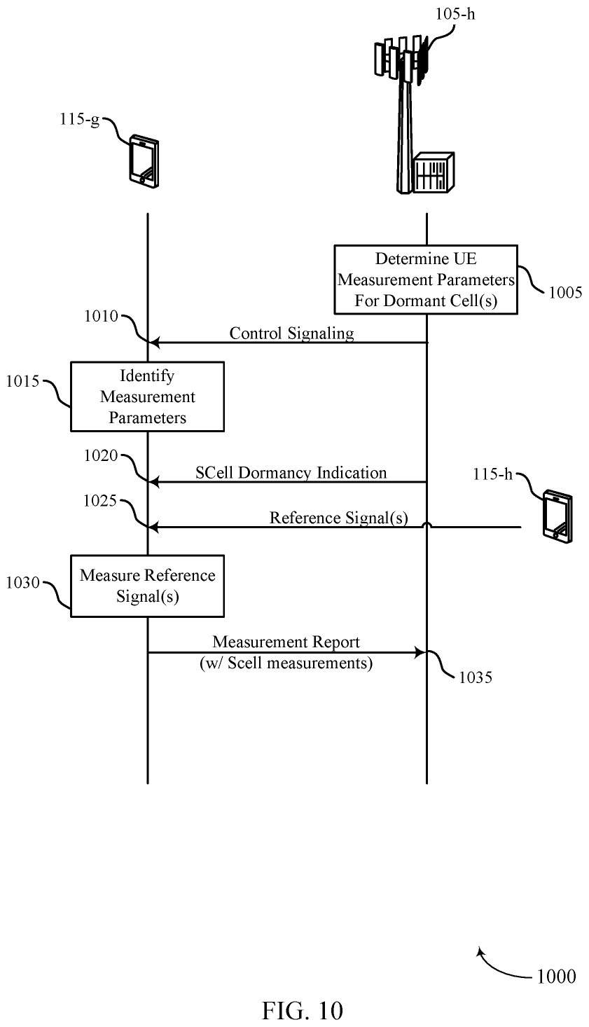

FIG. 10 illustrates an example of a process flow 1000 that supports CLI estimation on secondary cells for full-duplex communications in accordance with aspects of the present disclosure. In some examples, the process flow 1000 may implement aspects of wireless communication systems 100 or 200. For example, the process flow 1000 may include a base station 105-h and a UE 115-g, which may be examples of corresponding wireless devices as described herein. In the following description of the process flow 1000, the operations between the base station 105-h and the UE 115-g may be transmitted in a different order than the order shown, or the operations performed by the base station 105-h and the UE 115-g may be performed in different orders or at different times. Certain operations may also be left out of the process flow 1000, or other operations may be added to the process flow 1000. While the base station 105-h and the UE 115-g are shown performing operations of process flow 1000, any wireless device may perform the operations shown. Further, while FIG. 10 illustrates an example of communications between the base station 105-h and the UE 115-g, the techniques described herein may be applied to communications between any number of wireless devices. In the example of FIG. 10, the UE 115-g may be served by the base station 105-h, which may be an example of a serving base station and may be associated with a serving cell.

At 1005, the base station 105-g may determine UE measurement parameters for dormant cells. For example, the base station 105-h may determine CLI measurement resources for a SCell that is in a dormant state, PCell that are to be measured by the UE 115-g. At 1010, the base station 105-h may transmit, to the UE 115-g, control signaling (e.g., RRC signaling, a MAC-CE, DCI) indicating the measurement parameters.

At 1015, the UE 115-g may identify the measurement parameters. In some cases, the measurement parameters may be SCell measurement parameters that are to be used for CLI measurements on a dormant SCell. The measurement parameters may include, for example, a CLI measurement resource (e.g., corresponding to SRS resources on the SCell), a measurement report format for providing CLI measurements, a timing for transmitting measurement reports, or any combinations thereof.

At 1020, the base station 105-h may transmit a SCell dormancy indication, that may move an active SCell from a non-dormancy state to a dormant state. At 1025, an aggressor UE 115-h may transmit one or more reference signals, which may be received at the UE 115-g. The reference signals may include, for example, a SRS that is transmitted on the SCell. At 1030, the UE 115-g may measure the reference signals. In some cases, the UE 115-g may measure RSRP, RSSI, or similar parameters, using dormant SCell CLI measurement resources that are configured by the measurement parameters. At 1035, the UE 115-g may transmit a measurement report upon activation of SCell to the base station 105-h, which may include SCell CLI measurements that may be used to determine transmit parameters associated with the SCell.

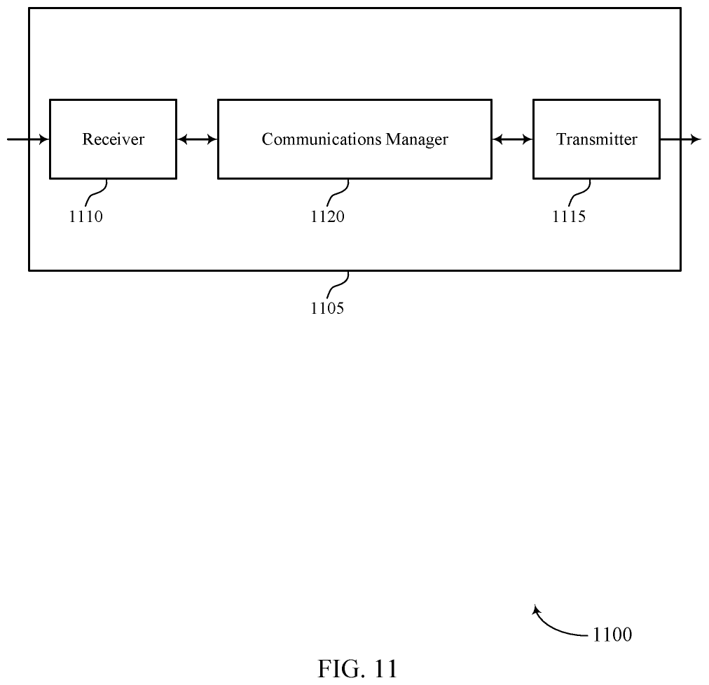

FIG. 11 shows a block diagram 1100 of a device 1105 that supports CLI estimation on secondary cells for full-duplex communications in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CLI estimation on secondary cells for full-duplex communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CLI estimation on secondary cells for full-duplex communications). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of CLI estimation on secondary cells for full-duplex communications as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. For example, the communications manager 1120 may be configured as or otherwise support a means for receiving, from a base station, control information that indicates one or more measurement parameters for a first cell, the one or more measurement parameters for identification of CLI of a second cell during concurrent uplink communications and downlink communications of the base station, such as cases in which the base station operates in a full duplex mode with one UE (e.g., a full-duplex UE) or with multiple UEs (e.g., each UE is a half-duplex UE). The communications manager 1120 may be configured as or otherwise support a means for measuring, based on the control information, one or more reference signals transmitted on the first cell to obtain a CLI measurement for the second cell. The communications manager 1120 may be configured as or otherwise support a means for transmitting a measurement report to the base station on the first cell that indicates the CLI measurement.

Additionally or alternatively, the communications manager 1120 may support wireless communication at a UE in accordance with examples as disclosed herein. For example, the communications manager 1120 may be configured as or otherwise support a means for receiving, from a base station, control information that indicates a first set of parameters for full-duplex communications of first cell and a second cell, and a second set of parameters for one or more measurements associated with the second cell. The communications manager 1120 may be configured as or otherwise support a means for receiving, from the base station, an indication that the second cell is in a dormant state. The communications manager 1120 may be configured as or otherwise support a means for measuring, during the dormant state of the second cell, one or more reference signals on the second cell based on the control information. The communications manager 1120 may be configured as or otherwise support a means for transmitting a measurement report to the base station that includes the one or more measurements of the one or more reference signals on the second cell.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for CLI estimations or measurements that may be used to set one or more transmission parameters to account for a presence or magnitude of CLI. Network efficiency and reliability may thus be enhanced through higher likelihood of successful communications, through more accurately tuned transmission parameters (e.g., transmit power, MCS, number of repetitions, etc.), or any combinations thereof.

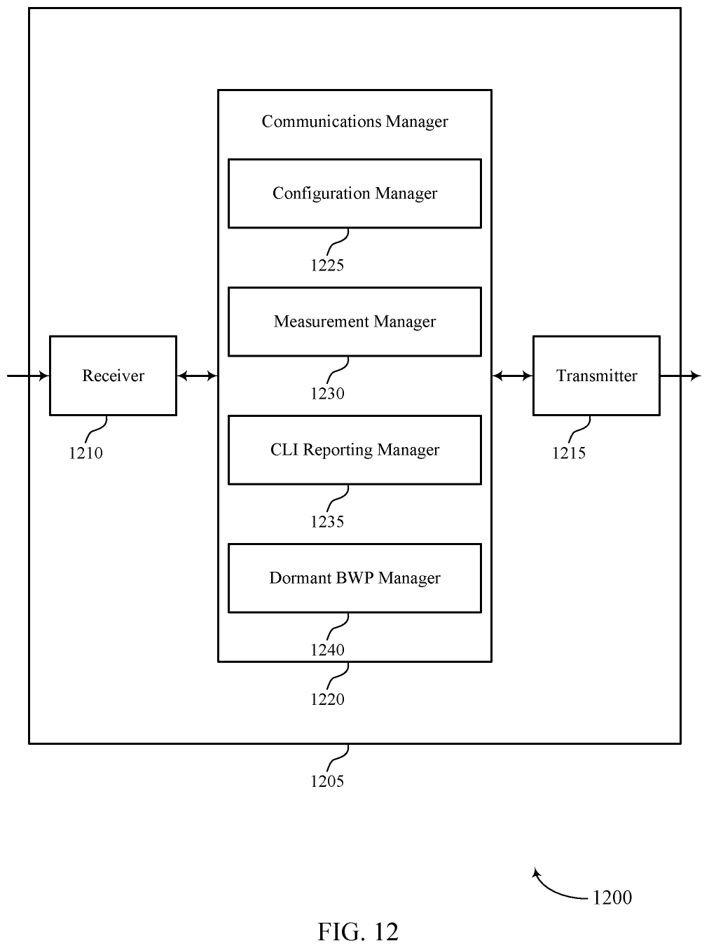

FIG. 12 shows a block diagram 1200 of a device 1205 that supports CLI estimation on secondary cells for full-duplex communications in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to CLI estimation on secondary cells for full-duplex communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to CLI estimation on secondary cells for full-duplex communications). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of CLI estimation on secondary cells for full-duplex communications as described herein. For example, the communications manager 1220 may include a configuration manager 1225, a measurement manager 1230, a CLI reporting manager 1235, a dormant BWP manager 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a UE in accordance with examples as disclosed herein. The configuration manager 1225 may be configured as or otherwise support a means for receiving, from a base station, control information that indicates one or more measurement parameters for a first cell, the one or more measurement parameters for identification of CLI of a second cell during concurrent uplink communications and downlink communications of the base station. The measurement manager 1230 may be configured as or otherwise support a means for measuring, based on the control information, one or more reference signals transmitted on the first cell to obtain a CLI measurement for the second cell. The CLI reporting manager 1235 may be configured as or otherwise support a means for transmitting a measurement report to the base station on the first cell that indicates the CLI measurement.

Additionally or alternatively, the communications manager 1220 may support wireless communication at a UE in accordance with examples as disclosed herein. The configuration manager 1225 may be configured as or otherwise support a means for receiving, from a base station, control information that indicates a first set of parameters for full-duplex communications of first cell and a second cell, and a second set of parameters for one or more measurements associated with the second cell. The dormant BWP manager 1240 may be configured as or otherwise support a means for receiving, from the base station, an indication that the second cell is in a dormant state. The dormant BWP manager 1240 may be configured as or otherwise support a means for measuring, during the dormant state of the second cell, one or more reference signals on the second cell based on the control information. The CLI reporting manager 1235 may be configured as or otherwise support a means for transmitting a measurement report to the base station that includes the one or more measurements of the one or more reference signals on the second cell.

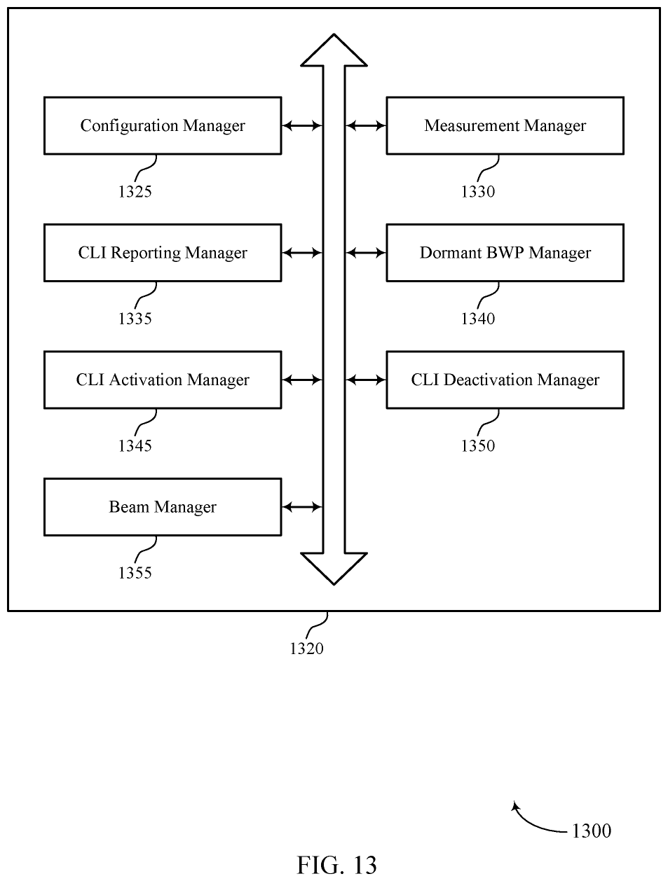

FIG. 13 shows a block diagram 1300 of a communications manager 1320 that supports CLI estimation on secondary cells for full-duplex communications in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of CLI estimation on secondary cells for full-duplex communications as described herein. For example, the communications manager 1320 may include a configuration manager 1325, a measurement manager 1330, a CLI reporting manager 1335, a dormant BWP manager 1340, a CLI activation manager 1345, a CLI deactivation manager 1350, a beam manager 1355, or any combination thereof. Each of these components may communicate, directly or indirectly, with one another (e.g., via one or more buses).

The communications manager 1320 may support wireless communication at a UE in accordance with examples as disclosed herein. The configuration manager 1325 may be configured as or otherwise support a means for receiving, from a base station, control information that indicates one or more measurement parameters for a first cell, the one or more measurement parameters for identification of CLI of a second cell during concurrent uplink communications and downlink communications of the base station. The measurement manager 1330 may be configured as or otherwise support a means for measuring, based on the control information, one or more reference signals transmitted on the first cell to obtain a CLI measurement for the second cell. The CLI reporting manager 1335 may be configured as or otherwise support a means for transmitting a measurement report to the base station on the first cell that indicates the CLI measurement.

In some examples, the first cell and the second cell operate in a same frequency band, and where the CLI measurement for the second cell is determined as a measurement of the one or more reference signals transmitted on the first cell. In some examples, the measurement of the one or more reference signals transmitted on the first cell is scaled based on a first channel bandwidth of the first cell and a second channel bandwidth of the second cell to determine the CLI measurement. In some examples, the first cell and the second cell operate in a same frequency band, and where the CLI measurement for the second cell is determined based on a scaling factor that is applied to a measurement of the one or more reference signals transmitted on the first cell. In some examples, the scaling factor is based on a difference between a first center frequency of the first cell and a second center frequency of the second cell. In some examples, the first cell operates in a first frequency band and the second cell operates in a second frequency band that is different than the first frequency band, and where the CLI measurement for the second cell is determined based on a propagation loss between the UE and a different UE that is based on one or more channel characteristics associated with the second frequency band.

In some examples, the one or more channel characteristics associated with the second frequency band include estimates of one or more of a path loss, a penetration loss, a foliage loss, a body block loss, an interference margin, a precipitation margin, a fading margin, or any combinations thereof. In some examples, the CLI measurement for the second cell is a FR2 measurement that is based on a FR1 measurement of the first cell, the propagation loss, and a link-budget associated with the second cell. In some examples, the CLI measurement for the second cell is a first CLI measurement for a SCell determined based on a PCell measurement, and a second CLI measurement is determined for a PSCell of a SCG, the second CLI measurement based on the PCell measurement.

In some examples, the CLI activation manager 1345 may be configured as or otherwise support a means for receiving, from the base station, an activation indication that communications on the second cell are enabled between the base station and a different UE. In some examples, the measurement manager 1330 may be configured as or otherwise support a means for measuring, based on the activation indication, the one or more reference signals transmitted on the second cell to obtain a second CLI measurement for the second cell. In some examples, the CLI deactivation manager 1350 may be configured as or otherwise support a means for discontinuing measuring the one or more reference signals transmitted on the second cell based on the different UE ceasing communications on the second cell.

In some examples, the CLI deactivation manager 1350 may be configured as or otherwise support a means for starting a deactivation timer responsive to receiving the activation indication, and where the discontinuing is based on an expiration of the deactivation timer. In some examples, the CLI deactivation manager 1350 may be configured as or otherwise support a means for determining that a RSRP of the one or more reference signals transmitted on the second cell exceeds a threshold value. In some examples, the CLI deactivation manager 1350 may be configured as or otherwise support a means for resetting the deactivation timer to an initial timer value responsive to the determining.

In some examples, the CLI activation manager 1345 may be configured as or otherwise support a means for receiving, from the base station, a reactivation indication to reactivate measurements of the one or more reference signals transmitted on the second cell. In some examples, the CLI activation manager 1345 may be configured as or otherwise support a means for resuming the measuring of the one or more reference signals transmitted on the second cell.

Additionally or alternatively, the communications manager 1320 may support wireless communication at a UE in accordance with examples as disclosed herein. In some examples, the configuration manager 1325 may be configured as or otherwise support a means for receiving, from a base station, control information that indicates a first set of parameters for full-duplex communications of first cell and a second cell, and a second set of parameters for one or more measurements associated with the second cell. The dormant BWP manager 1340 may be configured as or otherwise support a means for receiving, from the base station, an indication that the second cell is in a dormant state. In some examples, the dormant BWP manager 1340 may be configured as or otherwise support a means for measuring, during the dormant state of the second cell, one or more reference signals on the second cell based on the control information. In some examples, the CLI reporting manager 1335 may be configured as or otherwise support a means for transmitting a measurement report to the base station that includes the one or more measurements of the one or more reference signals on the second cell.

In some examples, the second set of parameters provide reference signal resources for measurements of the second cell when the second cell is in the dormant state. In some examples, the reference signal resources include periodic or semi-persistent reference signal resources for reference signal transmissions on the second cell.

In some examples, to support measuring, the dormant BWP manager 1340 may be configured as or otherwise support a means for receiving configuration for a default receive beam of the second cell for the one or more reference signals. In some examples, to support measuring, the dormant BWP manager 1340 may be configured as or otherwise support a means for measuring one or more of a RSRP or a RSSI of the one or more reference signals. In some examples, the second set of parameters provide spatial receiver parameters for a measurement resource of a receive beam of the second cell, and where the measuring includes. In some examples, monitoring the receive beam of the second cell for the one or more reference signals based on the spatial receiver parameters. In some examples, measuring one or more of a RSRP or a RSSI of the one or more reference signals.

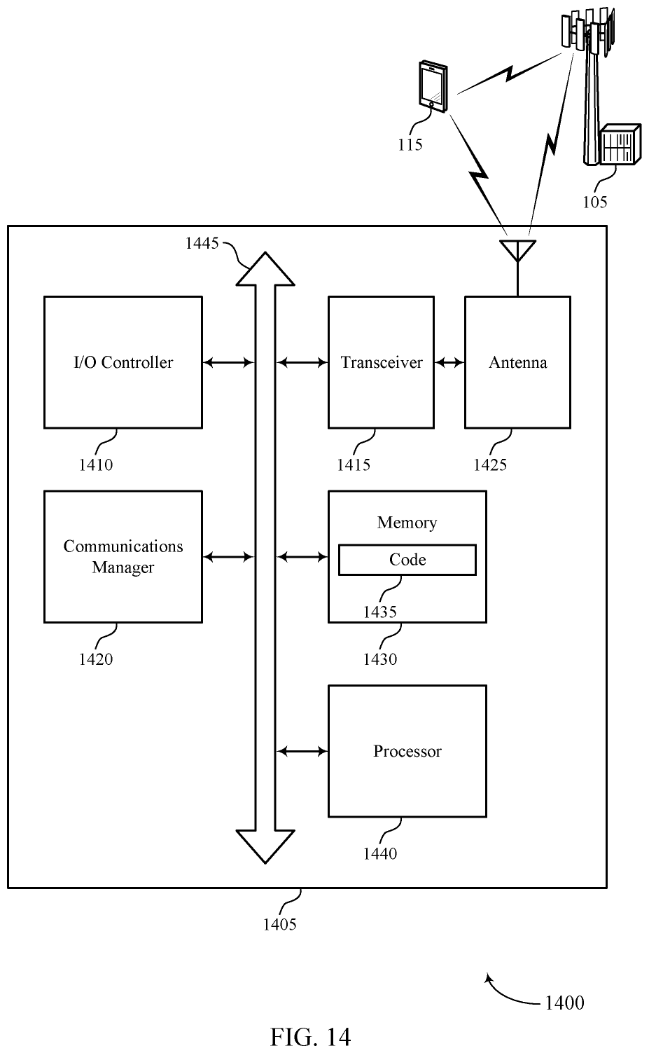

FIG. 14 shows a diagram of a system 1400 including a device 1405 that supports CLI estimation on secondary cells for full-duplex communications in accordance with aspects of the present disclosure. The device 1405 may be an example of or include the components of a device 1105, a device 1205, or a UE 115 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting CLI estimation on secondary cells for full-duplex communications). For example, the device 1405 or a component of the device 1405 may include a processor 1440 and memory 1430 coupled to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving, from a base station, control information that indicates one or more measurement parameters for a first cell, the one or more measurement parameters for identification of CLI of a second cell during concurrent uplink communications and downlink communications of the base station. The communications manager 1420 may be configured as or otherwise support a means for measuring, based on the control information, one or more reference signals transmitted on the first cell to obtain a CLI measurement for the second cell. The communications manager 1420 may be configured as or otherwise support a means for transmitting a measurement report to the base station on the first cell that indicates the CLI measurement.

Additionally or alternatively, the communications manager 1420 may support wireless communication at a UE in accordance with examples as disclosed herein. For example, the communications manager 1420 may be configured as or otherwise support a means for receiving, from a base station, control information that indicates a first set of parameters for full-duplex communications of first cell and a second cell, and a second set of parameters for one or more measurements associated with the second cell. The communications manager 1420 may be configured as or otherwise support a means for receiving, from the base station, an indication that the second cell is in a dormant state. The communications manager 1420 may be configured as or otherwise support a means for measuring, during the dormant state of the second cell, one or more reference signals on the second cell based on the control information. The communications manager 1420 may be configured as or otherwise support a means for transmitting a measurement report to the base station that includes the one or more measurements of the one or more reference signals on the second cell.

By including or configuring the communications manager 1420 in accordance with examples as described herein, the device 1405 may support techniques for CLI estimations or measurements that may be used to set one or more transmission parameters to account for a presence or magnitude of CLI. Network efficiency and reliability may thus be enhanced through higher likelihood of successful communications, through more accurately tuned transmission parameters (e.g., transmit power, MCS, number of repetitions, etc.), or any combinations thereof.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of CLI estimation on secondary cells for full-duplex communications as described herein, or the processor 1440 and the memory 1430 may be otherwise configured to perform or support such operations.

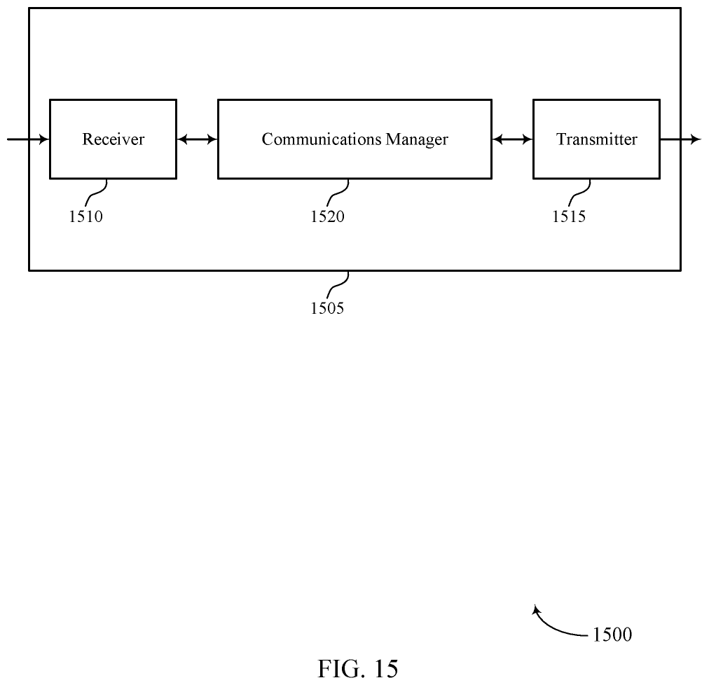

FIG. 15 shows a block diagram 1500 of a device 1505 that supports CLI estimation on secondary cells for full-duplex communications in accordance with aspects of the present disclosure. The device 1505 may be an example of aspects of a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to CLI estimation on secondary cells for full-duplex communications). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to CLI estimation on secondary cells for full-duplex communications). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of CLI estimation on secondary cells for full-duplex communications as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a base station in accordance with examples as disclosed herein. For example, the communications manager 1520 may be configured as or otherwise support a means for transmitting, to a UE, control information that indicates one or more measurement parameters of a first cell for identification of CLI at a second cell during concurrent uplink communications and downlink communications of the base station. The communications manager 1520 may be configured as or otherwise support a means for transmitting a reference signal on the first cell based on the control information. The communications manager 1520 may be configured as or otherwise support a means for receiving, from the UE, a measurement report that includes one or more measurements of the reference signal on the first cell. The communications manager 1520 may be configured as or otherwise support a means for determining, based on the measurement report, a CLI measurement for the second cell. The communications manager 1520 may be configured as or otherwise support a means for communicating with the UE on the second cell using one or more transmission parameters that are determined based on the CLI measurement.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for CLI estimations or measurements that may be used to set one or more transmission parameters to account for a presence or magnitude of CLI. Network efficiency and reliability may thus be enhanced through higher likelihood of successful communications, through more accurately tuned transmission parameters (e.g., transmit power, MCS, number of repetitions, etc.), or any combinations thereof.

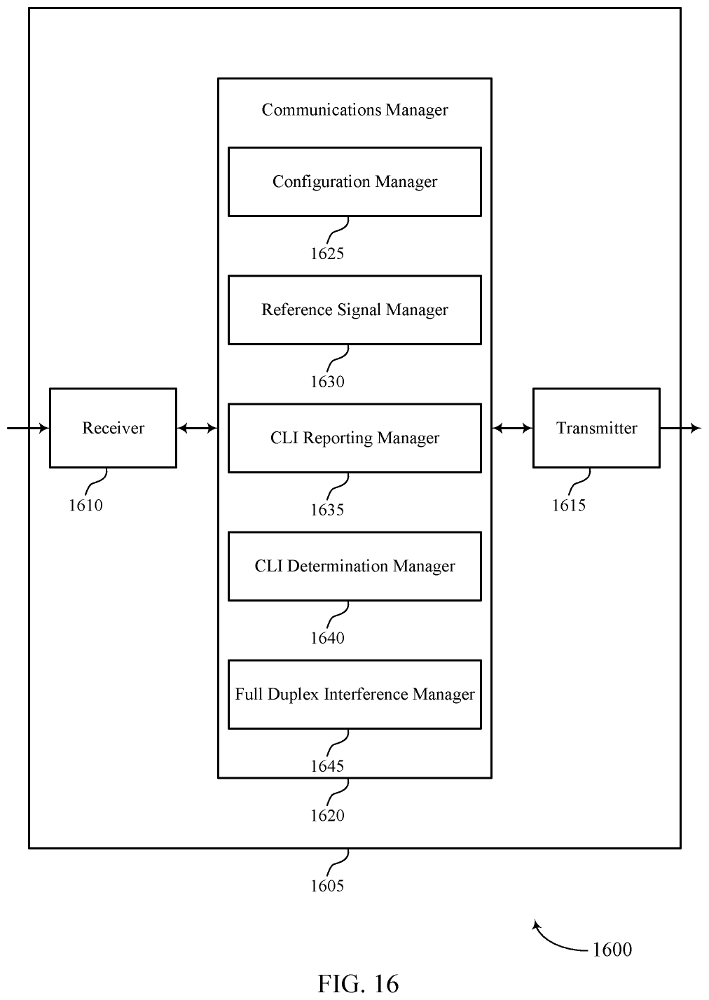

FIG. 16 shows a block diagram 1600 of a device 1605 that supports CLI estimation on secondary cells for full-duplex communications in accordance with aspects of the present disclosure. The device 1605 may be an example of aspects of a device 1505 or a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to CLI estimation on secondary cells for full-duplex communications). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to CLI estimation on secondary cells for full-duplex communications). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of CLI estimation on secondary cells for full-duplex communications as described herein. For example, the communications manager 1620 may include a configuration manager 1625, a reference signal manager 1630, a CLI reporting manager 1635, a CLI determination manager 1640, a full duplex interference manager 1645, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at a base station in accordance with examples as disclosed herein. The configuration manager 1625 may be configured as or otherwise support a means for transmitting, to a UE, control information that indicates one or more measurement parameters of a first cell for identification of CLI at a second cell during concurrent uplink communications and downlink communications of the base station. The reference signal manager 1630 may be configured as or otherwise support a means for transmitting a reference signal on the first cell based on the control information. The CLI reporting manager 1635 may be configured as or otherwise support a means for receiving, from the UE, a measurement report that includes one or more measurements of the reference signal on the first cell. The CLI determination manager 1640 may be configured as or otherwise support a means for determining, based on the measurement report, a CLI measurement for the second cell. The full duplex interference manager 1645 may be configured as or otherwise support a means for communicating with the UE on the second cell using one or more transmission parameters that are determined based on the CLI measurement.

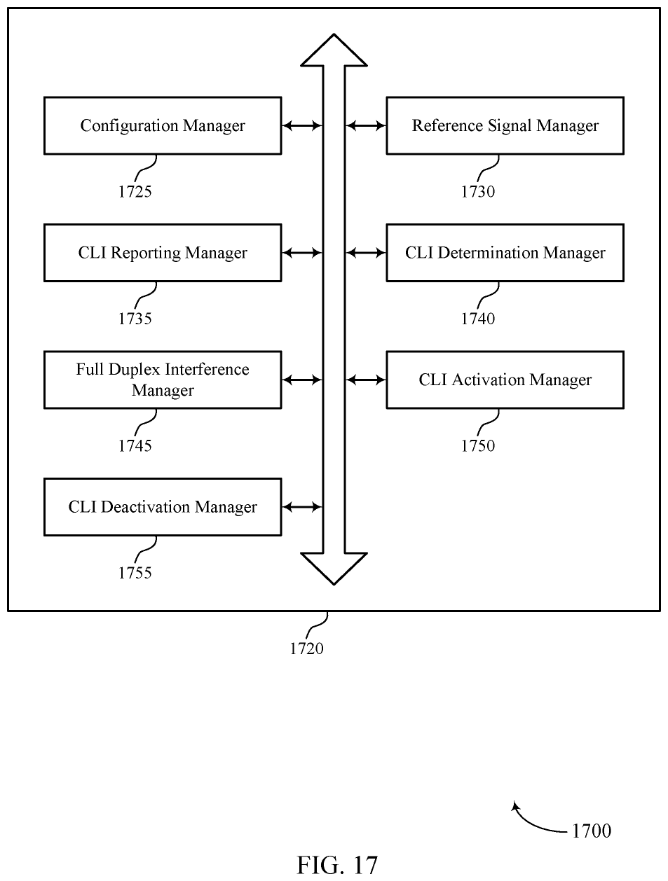

FIG. 17 shows a block diagram 1700 of a communications manager 1720 that supports CLI estimation on secondary cells for full-duplex communications in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of CLI estimation on secondary cells for full-duplex communications as described herein. For example, the communications manager 1720 may include a configuration manager 1725, a reference signal manager 1730, a CLI reporting manager 1735, a CLI determination manager 1740, a full duplex interference manager 1745, a CLI activation manager 1750, a CLI deactivation manager 1755, or any combination thereof. Each of these components may communicate, directly or indirectly, with one another (e.g., via one or more buses).

The communications manager 1720 may support wireless communication at a base station in accordance with examples as disclosed herein. The configuration manager 1725 may be configured as or otherwise support a means for transmitting, to a UE, control information that indicates one or more measurement parameters of a first cell for identification of CLI at a second cell during concurrent uplink communications and downlink communications of the base station. The reference signal manager 1730 may be configured as or otherwise support a means for transmitting a reference signal on the first cell based on the control information. The CLI reporting manager 1735 may be configured as or otherwise support a means for receiving, from the UE, a measurement report that includes one or more measurements of the reference signal on the first cell. The CLI determination manager 1740 may be configured as or otherwise support a means for determining, based on the measurement report, a CLI measurement for the second cell. The full duplex interference manager 1745 may be configured as or otherwise support a means for communicating with the UE on the second cell using one or more transmission parameters that are determined based on the CLI measurement.

In some examples, the first cell and the second cell operate in a same frequency band, and where the CLI measurement for the second cell is determined based on a scaling factor that is applied to the one or more measurements in the measurement report. In some examples, the first cell operates in a first frequency band and the second cell operates in a second frequency band that is different than the first frequency band, and where the CLI measurement for the second cell is determined based on a propagation loss associated with the UE that is based on one or more channel characteristics associated with the second frequency band. In some examples, the one or more channel characteristics associated with the second frequency band include estimates of one or more of a path loss, a penetration loss, a foliage loss, a body block loss, an interference margin, a precipitation margin, a fading margin, or any combinations thereof. In some examples, the CLI measurement for the second cell is a FR2 measurement that is based on a FR1 measurement of the first cell, the propagation loss, and a link-budget associated with the second cell. In some examples, the CLI measurement for the second cell is a first CLI measurement for a SCell determined based on a PCell measurement, and a second CLI measurement is determined for a PSCell of a SCG, the second CLI measurement passed on the PCell measurement.

In some examples, the CLI activation manager 1750 may be configured as or otherwise support a means for transmitting, to the UE, an activation indication that communications on the second cell are enabled between the base station and a different UE, the activation indication indicating to the UE to measure CLI on the second cell based on one or more reference signals transmitted on the second cell. In some examples, the CLI activation manager 1750 may be configured as or otherwise support a means for receiving, from the UE, one or more second cell CLI measurements responsive to the activation indication. In some examples, the CLI deactivation manager 1755 may be configured as or otherwise support a means for configuring the UE with a deactivation timer that is started responsive to the activation indication, and where the UE discontinues reference signal measurements on the second cell based on an expiration of the deactivation timer.

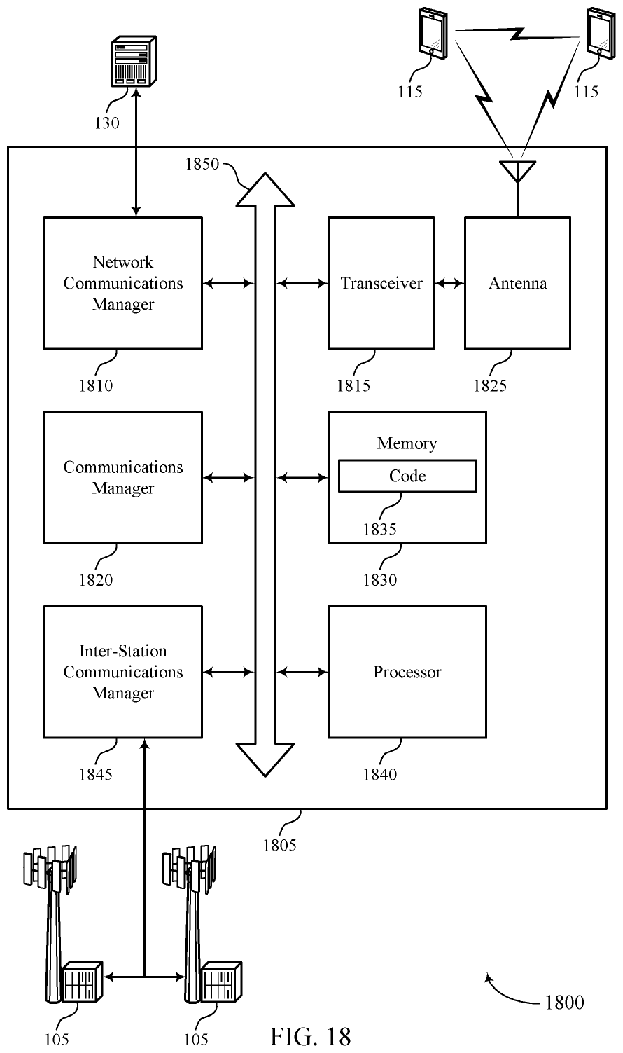

FIG. 18 shows a diagram of a system 1800 including a device 1805 that supports CLI estimation on secondary cells for full-duplex communications in accordance with aspects of the present disclosure. The device 1805 may be an example of or include the components of a device 1505, a device 1605, or a base station 105 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting CLI estimation on secondary cells for full-duplex communications). For example, the device 1805 or a component of the device 1805 may include a processor 1840 and memory 1830 coupled to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communication at a base station in accordance with examples as disclosed herein. For example, the communications manager 1820 may be configured as or otherwise support a means for transmitting, to a UE, control information that indicates one or more measurement parameters of a first cell for identification of CLI at a second cell during concurrent uplink communications and downlink communications of the base station. The communications manager 1820 may be configured as or otherwise support a means for transmitting a reference signal on the first cell based on the control information. The communications manager 1820 may be configured as or otherwise support a means for receiving, from the UE, a measurement report that includes one or more measurements of the reference signal on the first cell. The communications manager 1820 may be configured as or otherwise support a means for determining, based on the measurement report, a CLI measurement for the second cell. The communications manager 1820 may be configured as or otherwise support a means for communicating with the UE on the second cell using one or more transmission parameters that are determined based on the CLI measurement.

By including or configuring the communications manager 1820 in accordance with examples as described herein, the device 1805 may support techniques for CLI estimations or measurements that may be used to set one or more transmission parameters to account for a presence or magnitude of CLI. Network efficiency and reliability may thus be enhanced through higher likelihood of successful communications, through more accurately tuned transmission parameters (e.g., transmit power, MCS, number of repetitions, etc.), or any combinations thereof.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of CLI estimation on secondary cells for full-duplex communications as described herein, or the processor 1840 and the memory 1830 may be otherwise configured to perform or support such operations.

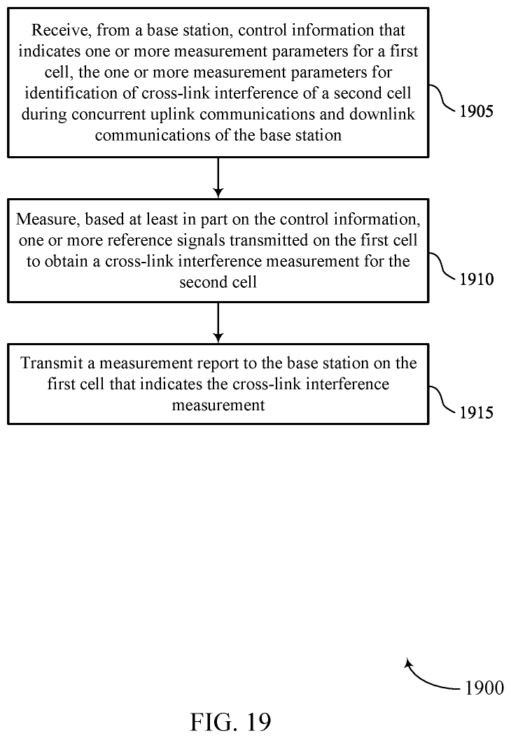

FIG. 19 shows a flowchart illustrating a method 1900 that supports CLI estimation on secondary cells for full-duplex communications in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, control information that indicates one or more measurement parameters for a first cell, the one or more measurement parameters for identification of CLI of a second cell during concurrent uplink communications and downlink communications of the base station. The operations of 1905 may be performed in accordance with examples as disclosed herein. In some examples, aspects of the operations of 1905 may be performed by a configuration manager 1325 as described with reference to FIG. 13.

At 1910, the method may include measuring, based on the control information, one or more reference signals transmitted on the first cell to obtain a CLI measurement for the second cell. The operations of 1910 may be performed in accordance with examples as disclosed herein. In some examples, aspects of the operations of 1910 may be performed by a measurement manager 1330 as described with reference to FIG. 13.

At 1915, the method may include transmitting a measurement report to the base station on the first cell that indicates the CLI measurement. The operations of 1915 may be performed in accordance with examples as disclosed herein. In some examples, aspects of the operations of 1915 may be performed by a CLI reporting manager 1335 as described with reference to FIG. 13.

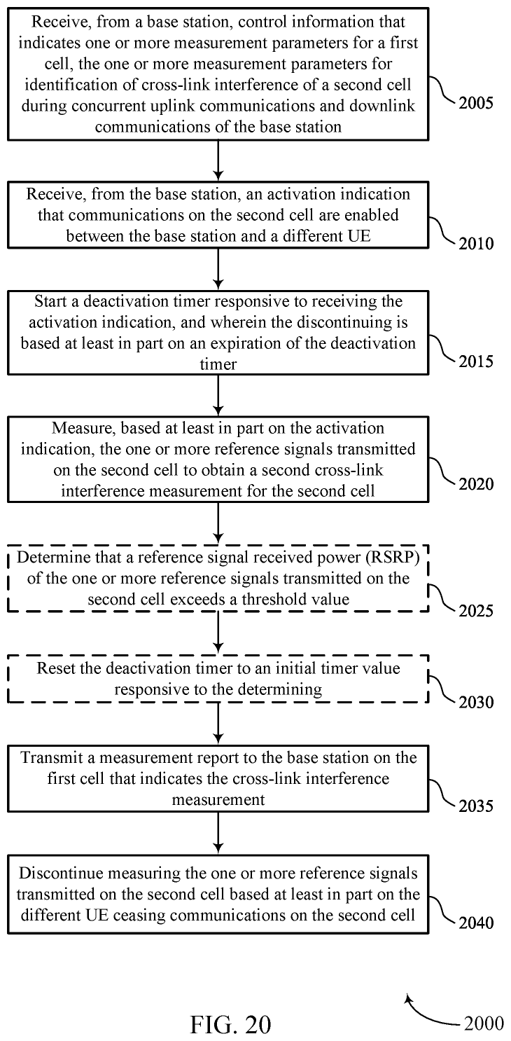

FIG. 20 shows a flowchart illustrating a method 2000 that supports CLI estimation on secondary cells for full-duplex communications in accordance with aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, control information that indicates one or more measurement parameters for a first cell, the one or more measurement parameters for identification of CLI of a second cell during concurrent uplink communications and downlink communications of the base station. The operations of 2005 may be performed in accordance with examples as disclosed herein. In some examples, aspects of the operations of 2005 may be performed by a configuration manager 1325 as described with reference to FIG. 13.

At 2010, the method may include receiving, from the base station, an activation indication that communications on the second cell are enabled between the base station and a different UE. The operations of 2010 may be performed in accordance with examples as disclosed herein. In some examples, aspects of the operations of 2010 may be performed by a CLI activation manager 1345 as described with reference to FIG. 13.

At 2015, the method may include starting a deactivation timer responsive to receiving the activation indication, and where the discontinuing is based on an expiration of the deactivation timer. The operations of 2015 may be performed in accordance with examples as disclosed herein. In some examples, aspects of the operations of 2015 may be performed by a CLI deactivation manager 1350 as described with reference to FIG. 13.

At 2020, the method may include measuring, based on the activation indication, the one or more reference signals transmitted on the second cell to obtain a second CLI measurement for the second cell. The operations of 2020 may be performed in accordance with examples as disclosed herein. In some examples, aspects of the operations of 2020 may be performed by a measurement manager 1330 as described with reference to FIG. 13.

Optionally, at 2025, the method may include determining that a RSRP of the one or more reference signals transmitted on the second cell exceeds a threshold value. The operations of 2025 may be performed in accordance with examples as disclosed herein. In some examples, aspects of the operations of 2025 may be performed by a CLI deactivation manager 1350 as described with reference to FIG. 13.

Optionally, at 2030, the method may include resetting the deactivation timer to an initial timer value responsive to the determining. The operations of 2030 may be performed in accordance with examples as disclosed herein. In some examples, aspects of the operations of 2030 may be performed by a CLI deactivation manager 1350 as described with reference to FIG. 13.

At 2035, the method may include transmitting a measurement report to the base station on the first cell that indicates the CLI measurement. The operations of 2035 may be performed in accordance with examples as disclosed herein. In some examples, aspects of the operations of 2035 may be performed by a CLI reporting manager 1335 as described with reference to FIG. 13.

At 2040, the method may include discontinuing measuring the one or more reference signals transmitted on the second cell based on the different UE ceasing communications on the second cell. The operations of 2040 may be performed in accordance with examples as disclosed herein. In some examples, aspects of the operations of 2040 may be performed by a CLI deactivation manager 1350 as described with reference to FIG. 13.

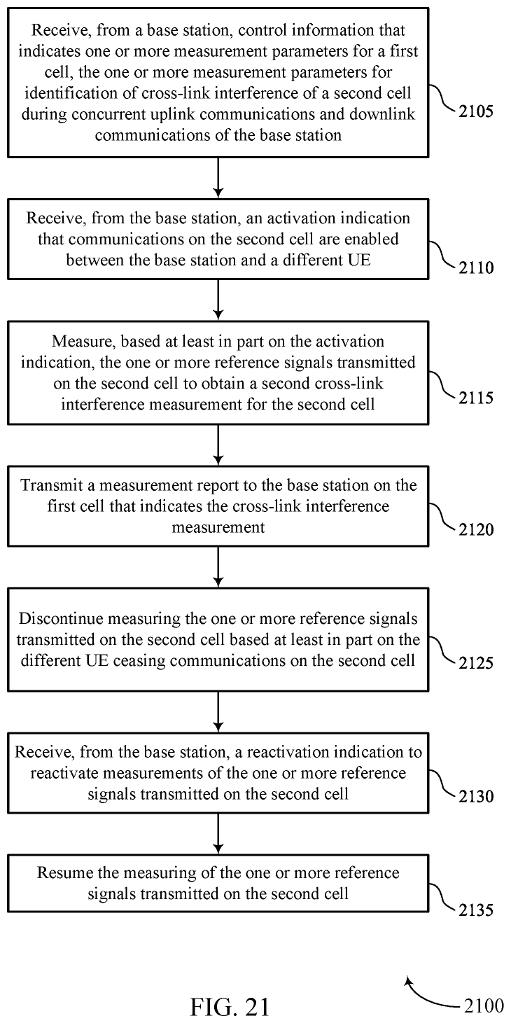

FIG. 21 shows a flowchart illustrating a method 2100 that supports CLI estimation on secondary cells for full-duplex communications in accordance with aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2105, the method may include receiving, from a base station, control information that indicates one or more measurement parameters for a first cell, the one or more measurement parameters for identification of CLI of a second cell during concurrent uplink communications and downlink communications of the base station. The operations of 2105 may be performed in accordance with examples as disclosed herein. In some examples, aspects of the operations of 2105 may be performed by a configuration manager 1325 as described with reference to FIG. 13.

At 2110, the method may include receiving, from the base station, an activation indication that communications on the second cell are enabled between the base station and a different UE. The operations of 2110 may be performed in accordance with examples as disclosed herein. In some examples, aspects of the operations of 2110 may be performed by a CLI activation manager 1345 as described with reference to FIG. 13.

At 2115, the method may include measuring, based on the control information, one or more reference signals transmitted on the first cell to obtain a CLI measurement for the second cell. The operations of 2115 may be performed in accordance with examples as disclosed herein. In some examples, aspects of the operations of 2115 may be performed by a measurement manager 1330 as described with reference to FIG. 13.

At 2120, the method may include transmitting a measurement report to the base station on the first cell that indicates the CLI measurement. The operations of 2120 may be performed in accordance with examples as disclosed herein. In some examples, aspects of the operations of 2120 may be performed by a CLI reporting manager 1335 as described with reference to FIG. 13.

At 2125, the method may include discontinuing measuring the one or more reference signals transmitted on the second cell based on the different UE ceasing communications on the second cell. The operations of 2125 may be performed in accordance with examples as disclosed herein. In some examples, aspects of the operations of 2125 may be performed by a CLI deactivation manager 1350 as described with reference to FIG. 13.

At 2130, the method may include receiving, from the base station, a reactivation indication to reactivate measurements of the one or more reference signals transmitted on the second cell. The operations of 2130 may be performed in accordance with examples as disclosed herein. In some examples, aspects of the operations of 2130 may be performed by a CLI activation manager 1345 as described with reference to FIG. 13.

At 2135, the method may include resuming the measuring of the one or more reference signals transmitted on the second cell. The operations of 2135 may be performed in accordance with examples as disclosed herein. In some examples, aspects of the operations of 2135 may be performed by a CLI activation manager 1345 as described with reference to FIG. 13.

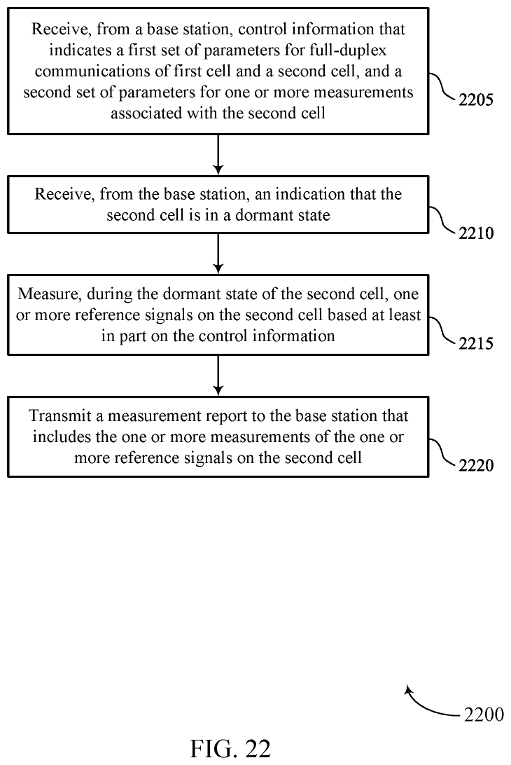

FIG. 22 shows a flowchart illustrating a method 2200 that supports CLI estimation on secondary cells for full-duplex communications in accordance with aspects of the present disclosure. The operations of the method 2200 may be implemented by a UE or its components as described herein. For example, the operations of the method 2200 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2205, the method may include receiving, from a base station, control information that indicates a first set of parameters for full-duplex communications of first cell and a second cell, and a second set of parameters for one or more measurements associated with the second cell. The operations of 2205 may be performed in accordance with examples as disclosed herein. In some examples, aspects of the operations of 2205 may be performed by a configuration manager 1325 as described with reference to FIG. 13.

At 2210, the method may include receiving, from the base station, an indication that the second cell is in a dormant state. The operations of 2210 may be performed in accordance with examples as disclosed herein. In some examples, aspects of the operations of 2210 may be performed by a dormant BWP manager 1340 as described with reference to FIG. 13.

At 2215, the method may include measuring, during the dormant state of the second cell, one or more reference signals on the second cell based on the control information. The operations of 2215 may be performed in accordance with examples as disclosed herein. In some examples, aspects of the operations of 2215 may be performed by a dormant BWP manager 1340 as described with reference to FIG. 13.

At 2220, the method may include transmitting a measurement report to the base station that includes the one or more measurements of the one or more reference signals on the second cell. The operations of 2220 may be performed in accordance with examples as disclosed herein. In some examples, aspects of the operations of 2220 may be performed by a CLI reporting manager 1335 as described with reference to FIG. 13.

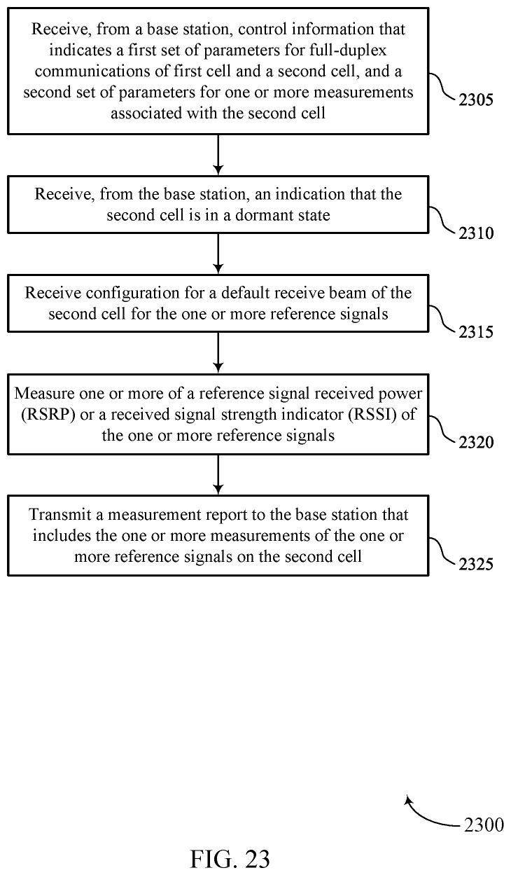

FIG. 23 shows a flowchart illustrating a method 2300 that supports CLI estimation on secondary cells for full-duplex communications in accordance with aspects of the present disclosure. The operations of the method 2300 may be implemented by a UE or its components as described herein. For example, the operations of the method 2300 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2305, the method may include receiving, from a base station, control information that indicates a first set of parameters for full-duplex communications of first cell and a second cell, and a second set of parameters for one or more measurements associated with the second cell. The operations of 2305 may be performed in accordance with examples as disclosed herein. In some examples, aspects of the operations of 2305 may be performed by a configuration manager 1325 as described with reference to FIG. 13.

At 2310, the method may include receiving, from the base station, an indication that the second cell is in a dormant state. The operations of 2310 may be performed in accordance with examples as disclosed herein. In some examples, aspects of the operations of 2310 may be performed by a dormant BWP manager 1340 as described with reference to FIG. 13.

At 2315, the method may include receiving configuration for a default receive beam of the second cell for the one or more reference signals. The operations of 2315 may be performed in accordance with examples as disclosed herein. In some examples, aspects of the operations of 2315 may be performed by a dormant BWP manager 1340 as described with reference to FIG. 13.

At 2320, the method may include measuring one or more of a RSRP or a RSSI of the one or more reference signals. The operations of 2320 may be performed in accordance with examples as disclosed herein. In some examples, aspects of the operations of 2320 may be performed by a dormant BWP manager 1340 as described with reference to FIG. 13.

At 2325, the method may include transmitting a measurement report to the base station that includes the one or more measurements of the one or more reference signals on the second cell. The operations of 2325 may be performed in accordance with examples as disclosed herein. In some examples, aspects of the operations of 2325 may be performed by a CLI reporting manager 1335 as described with reference to FIG. 13.

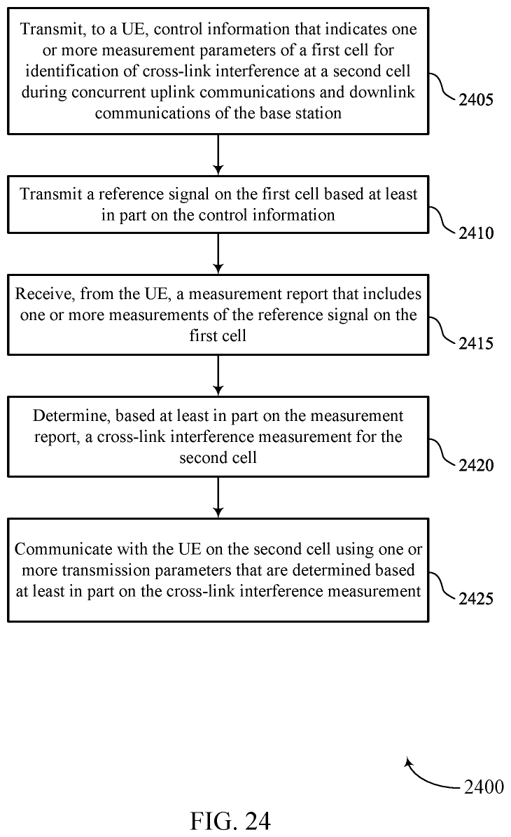

FIG. 24 shows a flowchart illustrating a method 2400 that supports CLI estimation on secondary cells for full-duplex communications in accordance with aspects of the present disclosure. The operations of the method 2400 may be implemented by a base station or its components as described herein. For example, the operations of the method 2400 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2405, the method may include transmitting, to a UE, control information that indicates one or more measurement parameters of a first cell for identification of CLI at a second cell during concurrent uplink communications and downlink communications of the base station. The operations of 2405 may be performed in accordance with examples as disclosed herein. In some examples, aspects of the operations of 2405 may be performed by a configuration manager 1725 as described with reference to FIG. 17.

At 2410, the method may include transmitting a reference signal on the first cell based on the control information. The operations of 2410 may be performed in accordance with examples as disclosed herein. In some examples, aspects of the operations of 2410 may be performed by a reference signal manager 1730 as described with reference to FIG. 17.

At 2415, the method may include receiving, from the UE, a measurement report that includes one or more measurements of the reference signal on the first cell. The operations of 2415 may be performed in accordance with examples as disclosed herein. In some examples, aspects of the operations of 2415 may be performed by a CLI reporting manager 1735 as described with reference to FIG. 17.

At 2420, the method may include determining, based on the measurement report, a CLI measurement for the second cell. The operations of 2420 may be performed in accordance with examples as disclosed herein. In some examples, aspects of the operations of 2420 may be performed by a CLI determination manager 1740 as described with reference to FIG. 17.

At 2425, the method may include communicating with the UE on the second cell using one or more transmission parameters that are determined based on the CLI measurement. The operations of 2425 may be performed in accordance with examples as disclosed herein. In some examples, aspects of the operations of 2425 may be performed by a full duplex interference manager 1745 as described with reference to FIG. 17.

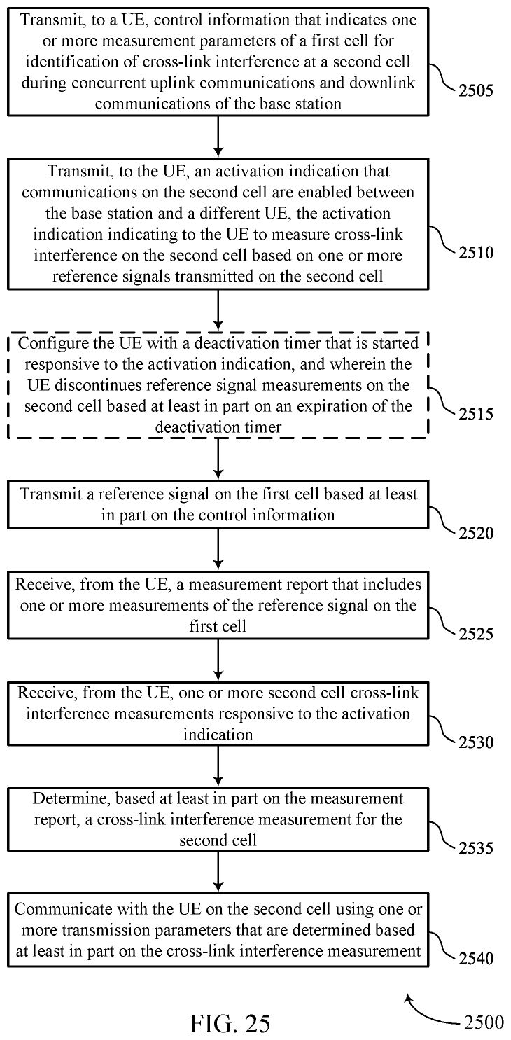

FIG. 25 shows a flowchart illustrating a method 2500 that supports CLI estimation on secondary cells for full-duplex communications in accordance with aspects of the present disclosure. The operations of the method 2500 may be implemented by a base station or its components as described herein. For example, the operations of the method 2500 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2505, the method may include transmitting, to a UE, control information that indicates one or more measurement parameters of a first cell for identification of CLI at a second cell during concurrent uplink communications and downlink communications of the base station. The operations of 2505 may be performed in accordance with examples as disclosed herein. In some examples, aspects of the operations of 2505 may be performed by a configuration manager 1725 as described with reference to FIG. 17.

At 2510, the method may include transmitting, to the UE, an activation indication that communications on the second cell are enabled between the base station and a different UE, the activation indication indicating to the UE to measure CLI on the second cell based on one or more reference signals transmitted on the second cell. The operations of 2510 may be performed in accordance with examples as disclosed herein. In some examples, aspects of the operations of 2510 may be performed by a CLI activation manager 1750 as described with reference to FIG. 17.

Optionally, at 2515, the method may include configuring the UE with a deactivation timer that is started responsive to the activation indication, and where the UE discontinues reference signal measurements on the second cell based on an expiration of the deactivation timer. The operations of 2515 may be performed in accordance with examples as disclosed herein. In some examples, aspects of the operations of 2515 may be performed by a CLI deactivation manager 1755 as described with reference to FIG. 17.

At 2520, the method may include transmitting a reference signal on the first cell based on the control information. The operations of 2520 may be performed in accordance with examples as disclosed herein. In some examples, aspects of the operations of 2520 may be performed by a reference signal manager 1730 as described with reference to FIG. 17.

At 2525, the method may include receiving, from the UE, a measurement report that includes one or more measurements of the reference signal on the first cell. The operations of 2525 may be performed in accordance with examples as disclosed herein. In some examples, aspects of the operations of 2525 may be performed by a CLI reporting manager 1735 as described with reference to FIG. 17.

At 2530, the method may include receiving, from the UE, one or more second cell CLI measurements responsive to the activation indication. The operations of 2530 may be performed in accordance with examples as disclosed herein. In some examples, aspects of the operations of 2530 may be performed by a CLI activation manager 1750 as described with reference to FIG. 17.

At 2535, the method may include determining, based on the measurement report, a CLI measurement for the second cell. The operations of 2535 may be performed in accordance with examples as disclosed herein. In some examples, aspects of the operations of 2535 may be performed by a CLI determination manager 1740 as described with reference to FIG. 17.

At 2540, the method may include communicating with the UE on the second cell using one or more transmission parameters that are determined based on the CLI measurement. The operations of 2540 may be performed in accordance with examples as disclosed herein. In some examples, aspects of the operations of 2540 may be performed by a full duplex interference manager 1745 as described with reference to FIG. 17.

The following provides an overview of aspects of the present disclosure:

Aspect 1: A method for wireless communication at a UE, comprising: receiving, from a base station, control information that indicates one or more measurement parameters for a first cell, the one or more measurement parameters for identification of cross-link interference of a second cell during concurrent uplink communications and downlink communications of the base station; measuring, based at least in part on the control information, one or more reference signals transmitted on the first cell to obtain a cross-link interference measurement for the second cell; and transmitting a measurement report to the base station on the first cell that indicates the cross-link interference measurement.

Aspect 2: The method of aspect 1, wherein the first cell and the second cell operate in a same frequency band, and the cross-link interference measurement for the second cell is determined as a measurement of the one or more reference signals transmitted on the first cell.

Aspect 3: The method of aspect 2, wherein the measurement of the one or more reference signals transmitted on the first cell is scaled based at least in part on a first channel bandwidth of the first cell and a second channel bandwidth of the second cell to determine the cross-link interference measurement.

Aspect 4: The method of any of aspect 1, wherein the first cell and the second cell operate in a same frequency band, and the cross-link interference measurement for the second cell is determined based on a scaling factor that is applied to a measurement of the one or more reference signals transmitted on the first cell.

Aspect 5: The method of aspect 4, wherein the scaling factor is based at least in part on a difference between a first center frequency of the first cell and a second center frequency of the second cell.

Aspect 6: The method of any of aspects 4 through 5, wherein the first cell operates in a first frequency band and the second cell operates in a second frequency band that is different than the first frequency band, and the cross-link interference measurement for the second cell is determined based on a propagation loss between the UE and a different UE that is based at least in part on one or more channel characteristics associated with the second frequency band.

Aspect 7: The method of aspect 6, wherein the one or more channel characteristics associated with the second frequency band include estimates of one or more of a path loss, a penetration loss, a foliage loss, a body block loss, an interference margin, a precipitation margin, a fading margin, or any combinations thereof.

Aspect 8: The method of any of aspects 6 through 7, wherein the cross-link interference measurement for the second cell is a frequency range two (FR2) measurement that is based on a frequency range one (FR1) measurement of the first cell, the propagation loss, and a link-budget associated with the second cell.

Aspect 9: The method of any of aspects 1 through 8, wherein the cross-link interference measurement for the second cell is a first cross-link interference measurement for a secondary cell (SCell) determined based on a primary cell (PCell) measurement, and a second cross-link interference measurement is determined for a primary SCell (PSCell) of a secondary carrier group (SCG), the second cross-link interference measurement based on the PCell measurement.

Aspect 10: The method of any of aspects 1 through 9, further comprising: receiving, from the base station, an activation indication that communications on the second cell are enabled between the base station and a different UE; measuring, based at least in part on the activation indication, the one or more reference signals transmitted on the second cell to obtain a second cross-link interference measurement for the second cell; and discontinuing measuring the one or more reference signals transmitted on the second cell based at least in part on the different UE ceasing communications on the second cell.

Aspect 11: The method of aspect 10, further comprising: starting a deactivation timer responsive to receiving the activation indication, and wherein the discontinuing is based at least in part on an expiration of the deactivation timer.

Aspect 12: The method of aspect 11, further comprising: determining that a reference signal received power (RSRP) of the one or more reference signals transmitted on the second cell exceeds a threshold value; and resetting the deactivation timer to an initial timer value responsive to the determining.

Aspect 13: The method of any of aspects 10 through 12, further comprising: receiving, from the base station, a reactivation indication to reactivate measurements of the one or more reference signals transmitted on the second cell; and resuming the measuring of the one or more reference signals transmitted on the second cell.

Aspect 14: A method for wireless communication at a UE, comprising: receiving, from a base station, control information that indicates a first set of parameters for full-duplex communications of first cell and a second cell, and a second set of parameters for one or more measurements associated with the second cell; receiving, from the base station, an indication that the second cell is in a dormant state; measuring, during the dormant state of the second cell, one or more reference signals on the second cell based at least in part on the control information; and transmitting a measurement report to the base station that includes the one or more measurements of the one or more reference signals on the second cell.

Aspect 15: The method of aspect 14, wherein the second set of parameters provide reference signal resources for measurements of the second cell when the second cell is in the dormant state.

Aspect 16: The method of aspect 15, wherein the reference signal resources include periodic or semi-persistent reference signal resources for reference signal transmissions on the second cell.

Aspect 17: The method of any of aspects 14 through 16, wherein the measuring comprises: receiving configuration for a default receive beam of the second cell for the one or more reference signals; and measuring one or more of a reference signal received power (RSRP) or a received signal strength indicator (RSSI) of the one or more reference signals.

Aspect 18: The method of any of aspects 14 through 17, wherein the second set of parameters provide spatial receiver parameters for a measurement resource of a receive beam of the second cell, and wherein the measuring comprises: monitoring the receive beam of the second cell for the one or more reference signals based at least in part on the spatial receiver parameters; and measuring one or more of a reference signal received power (RSRP) or a received signal strength indicator (RSSI) of the one or more reference signals.

Aspect 19: A method for wireless communication at a base station, comprising: transmitting, to a UE, control information that indicates one or more measurement parameters of a first cell for identification of cross-link interference at a second cell during concurrent uplink communications and downlink communications of the base station; transmitting a reference signal on the first cell based at least in part on the control information; receiving, from the UE, a measurement report that includes one or more measurements of the reference signal on the first cell; determining, based at least in part on the measurement report, a cross-link interference measurement for the second cell; and communicating with the UE on the second cell using one or more transmission parameters that are determined based at least in part on the cross-link interference measurement.

Aspect 20: The method of aspect 19, wherein the first cell and the second cell operate in a same frequency band, and the cross-link interference measurement for the second cell is determined based at least in part on a scaling factor that is applied to the one or more measurements in the measurement report.

Aspect 21: The method of any of aspects 19 through 20, wherein the first cell operates in a first frequency band and the second cell operates in a second frequency band that is different than the first frequency band, and the cross-link interference measurement for the second cell is determined based on a propagation loss associated with the UE that is based at least in part on one or more channel characteristics associated with the second frequency band.

Aspect 22: The method of aspect 21, wherein the one or more channel characteristics associated with the second frequency band include estimates of one or more of a path loss, a penetration loss, a foliage loss, a body block loss, an interference margin, a precipitation margin, a fading margin, or any combinations thereof.

Aspect 23: The method of any of aspects 21 through 22, wherein the cross-link interference measurement for the second cell is a frequency range two (FR2) measurement that is based on a frequency range one (FR1) measurement of the first cell, the propagation loss, and a link-budget associated with the second cell.

Aspect 24: The method of any of aspects 19 through 23, wherein the cross-link interference measurement for the second cell is a first cross-link interference measurement for a secondary cell (SCell) determined based on a primary cell (PCell) measurement, and a second cross-link interference measurement is determined for a primary SCell (PSCell) of a secondary carrier group (SCG), the second cross-link interference measurement passed on the PCell measurement.

Aspect 25: The method of any of aspects 19 through 24, further comprising: transmitting, to the UE, an activation indication that communications on the second cell are enabled between the base station and a different UE, the activation indication indicating to the UE to measure cross-link interference on the second cell based on one or more reference signals transmitted on the second cell; and receiving, from the UE, one or more second cell cross-link interference measurements responsive to the activation indication.

Aspect 26: The method of aspect 25, further comprising: configuring the UE with a deactivation timer that is started responsive to the activation indication, and wherein the UE discontinues reference signal measurements on the second cell based at least in part on an expiration of the deactivation timer.

Aspect 27: An apparatus for wireless communication at a UE, comprising a processor; memory coupled with the processor; and instructions stored in the memory and executable by the processor to cause the apparatus to perform a method of any of aspects 1 through 13.

Aspect 28: An apparatus for wireless communication at a UE, comprising at least one means for performing a method of any of aspects 1 through 13.

Aspect 29: A non-transitory computer-readable medium storing code for wireless communication at a UE, the code comprising instructions executable by a processor to perform a method of any of aspects 1 through 13.

Aspect 30: An apparatus for wireless communication at a UE, comprising a processor; memory coupled with the processor; and instructions stored in the memory and executable by the processor to cause the apparatus to perform a method of any of aspects 14 through 18.

Aspect 31: An apparatus for wireless communication at a UE, comprising at least one means for performing a method of any of aspects 14 through 18.

Aspect 32: A non-transitory computer-readable medium storing code for wireless communication at a UE, the code comprising instructions executable by a processor to perform a method of any of aspects 14 through 18.

Aspect 33: An apparatus for wireless communication at a base station, comprising a processor; memory coupled with the processor; and instructions stored in the memory and executable by the processor to cause the apparatus to perform a method of any of aspects 19 through 26.

Aspect 34: An apparatus for wireless communication at a base station, comprising at least one means for performing a method of any of aspects 19 through 26.

Aspect 35: A non-transitory computer-readable medium storing code for wireless communication at a base station, the code comprising instructions executable by a processor to perform a method of any of aspects 19 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control information that indicates one or more measurement parameters for a first cell, the one or more measurement parameters for identification of cross-link interference of a second cell during concurrent uplink communications and downlink communications of the base station;
measuring, based at least in part on the control information, one or more reference signals transmitted on the first cell to obtain a cross-link interference measurement for the second cell; and
transmitting a measurement report to the base station on the first cell that indicates the cross-link interference measurement.

2. The method of claim 1, wherein the first cell and the second cell operate in a same frequency band, and wherein the cross-link interference measurement for the second cell is determined as a measurement of the one or more reference signals transmitted on the first cell.

3. The method of claim 2, wherein the measurement of the one or more reference signals transmitted on the first cell is scaled based at least in part on a first channel bandwidth of the first cell and a second channel bandwidth of the second cell to determine the cross-link interference measurement.

4. The method of claim 1, wherein the first cell and the second cell operate in a same frequency band, and wherein the cross-link interference measurement for the second cell is determined based on a scaling factor that is applied to a measurement of the one or more reference signals transmitted on the first cell.

5. The method of claim 4, wherein the scaling factor is based at least in part on a difference between a first center frequency of the first cell and a second center frequency of the second cell.

6. The method of claim 1, wherein the first cell operates in a first frequency band and the second cell operates in a second frequency band that is different than the first frequency band, and wherein the cross-link interference measurement for the second cell is determined based on a propagation loss between the UE and a different UE that is based at least in part on one or more channel characteristics associated with the second frequency band.

7. The method of claim 6, wherein the one or more channel characteristics associated with the second frequency band include estimates of one or more of a path loss, a penetration loss, a foliage loss, a body block loss, an interference margin, a precipitation margin, a fading margin, or any combinations thereof.

8. The method of claim 6, wherein the cross-link interference measurement for the second cell is a frequency range two (FR2) measurement that is based on a frequency range one (FR1) measurement of the first cell, the propagation loss, and a link-budget associated with the second cell.

9. The method of claim 1, wherein the cross-link interference measurement for the second cell is a first cross-link interference measurement for a secondary cell (SCell) determined based on a primary cell (PCell) measurement, and a second cross-link interference measurement is determined for a primary SCell (PSCell) of a secondary carrier group (SCG), the second cross-link interference measurement based on the PCell measurement.

10. The method of claim 1, further comprising:
receiving, from the base station, an activation indication that communications on the second cell are enabled between the base station and a different UE;
measuring, based at least in part on the activation indication, the one or more reference signals transmitted on the second cell to obtain a second cross-link interference measurement for the second cell; and
discontinuing measuring the one or more reference signals transmitted on the second cell based at least in part on the different UE ceasing communications on the second cell.

11. The method of claim 10, further comprising:
starting a deactivation timer responsive to receiving the activation indication, and wherein the discontinuing is based at least in part on an expiration of the deactivation timer.

12. The method of claim 11, further comprising:
determining that a reference signal received power (RSRP) of the one or more reference signals transmitted on the second cell exceeds a threshold value; and
resetting the deactivation timer to an initial timer value responsive to the determining.

13. The method of claim 10, further comprising:
receiving, from the base station, a reactivation indication to reactivate measurements of the one or more reference signals transmitted on the second cell; and
resuming the measuring of the one or more reference signals transmitted on the second cell.

14. A method for wireless communication at a user equipment (UE), comprising:
receiving, from a base station, control information that indicates a first set of parameters for full-duplex communications of first cell and a second cell, and a second set of parameters for one or more measurements associated with the second cell;
receiving, from the base station, an indication that the second cell is in a dormant state;
measuring, during the dormant state of the second cell, one or more reference signals on the second cell based at least in part on the control information; and
transmitting a measurement report to the base station that includes the one or more measurements of the one or more reference signals on the second cell.

15. The method of claim 14, wherein the second set of parameters provide reference signal resources for measurements of the second cell when the second cell is in the dormant state.

16. The method of claim 15, wherein the reference signal resources include periodic or semi-persistent reference signal resources for reference signal transmissions on the second cell.

17. The method of claim 14, wherein the measuring comprises:
receiving configuration for a default receive beam of the second cell for the one or more reference signals; and
measuring one or more of a reference signal received power (RSRP) or a received signal strength indicator (RSSI) of the one or more reference signals.

18. The method of claim 14, wherein:
the second set of parameters provide spatial receiver parameters for a measurement resource of a receive beam of the second cell, and wherein the measuring comprises:
monitoring the receive beam of the second cell for the one or more reference signals based at least in part on the spatial receiver parameters; and
measuring one or more of a reference signal received power (RSRP) or a received signal strength indicator (RSSI) of the one or more reference signals.

19. A method for wireless communication at a base station, comprising:
transmitting, to a user equipment (UE), control information that indicates one or more measurement parameters of a first cell for identification of cross-link interference at a second cell during concurrent uplink communications and downlink communications of the base station;
transmitting a reference signal on the first cell based at least in part on the control information;
receiving, from the UE, a measurement report that includes one or more measurements of the reference signal on the first cell;
determining, based at least in part on the measurement report, a cross-link interference measurement for the second cell; and
communicating with the UE on the second cell using one or more transmission parameters that are determined based at least in part on the cross-link interference measurement.

20. The method of claim 19, wherein the first cell and the second cell operate in a same frequency band, and wherein the cross-link interference measurement for the second cell is determined based at least in part on a scaling factor that is applied to the one or more measurements in the measurement report.

21. The method of claim 19, wherein the first cell operates in a first frequency band and the second cell operates in a second frequency band that is different than the first frequency band, and wherein the cross-link interference measurement for the second cell is determined based on a propagation loss associated with the UE that is based at least in part on one or more channel characteristics associated with the second frequency band.

22. The method of claim 21, wherein the one or more channel characteristics associated with the second frequency band include estimates of one or more of a path loss, a penetration loss, a foliage loss, a body block loss, an interference margin, a precipitation margin, a fading margin, or any combinations thereof.

23. The method of claim 21, wherein the cross-link interference measurement for the second cell is a frequency range two (FR2) measurement that is based on a frequency range one (FR1) measurement of the first cell, the propagation loss, and a link-budget associated with the second cell.

24. The method of claim 19, wherein the cross-link interference measurement for the second cell is a first cross-link interference measurement for a secondary cell (SCell) determined based on a primary cell (PCell) measurement, and a second cross-link interference measurement is determined for a primary SCell (PSCell) of a secondary carrier group (SCG), the second cross-link interference measurement passed on the PCell measurement.

25. The method of claim 19, further comprising:
transmitting, to the UE, an activation indication that communications on the second cell are enabled between the base station and a different UE, the activation indication indicating to the UE to measure cross-link interference on the second cell based on one or more reference signals transmitted on the second cell; and
receiving, from the UE, one or more second cell cross-link interference measurements responsive to the activation indication.

26. The method of claim 25, further comprising:
configuring the UE with a deactivation timer that is started responsive to the activation indication, and wherein the UE discontinues reference signal measurements on the second cell based at least in part on an expiration of the deactivation timer.

27. An apparatus for wireless communication at a user equipment (UE), comprising:
a processor;
memory coupled with the processor; and
instructions stored in the memory and executable by the processor to cause the apparatus to:
receive, from a base station, control information that indicates one or more measurement parameters for a first cell, the one or more measurement parameters for identification of cross-link interference of a second cell during concurrent uplink communications and downlink communications of the base station;
measure, based at least in part on the control information, one or more reference signals transmitted on the first cell to obtain a cross-link interference measurement for the second cell; and
transmit a measurement report to the base station on the first cell that indicates the cross-link interference measurement.

28. The apparatus of claim 27, wherein the first cell and the second cell operate in a same frequency band, and wherein the cross-link interference measurement for the second cell is determined as a measurement of the one or more reference signals transmitted on the first cell.

29. The apparatus of claim 27, wherein the first cell and the second cell operate in a same frequency band, and wherein the cross-link interference measurement for the second cell is determined based on a scaling factor that is applied to a measurement of the one or more reference signals transmitted on the first cell.

30. The apparatus of claim 27, wherein the instructions are further executable by the processor to cause the apparatus to:
receive, from the base station, an activation indication that communications on the second cell are enabled between the base station and a different UE;
measure, based at least in part on the activation indication, the one or more reference signals transmitted on the second cell to obtain a second cross-link interference measurement for the second cell; and
discontinue measuring the one or more reference signals transmitted on the second cell based at least in part on the different UE ceasing communications on the second cell.
